(19) United States
(12) Patent Application Publication
(10) Pub. No.: US 2025/0132966 A1
(43) Pub. Date: Apr. 24, 2025

(54) COMMUNICATION METHOD AND COMMUNICATION APPARATUS

(71) Applicant: HUAWEI TECHNOLOGIES CO., LTD., Shenzhen (CN)

(72) Inventors: Xiaolu WANG, Hangzhou (CN); Yunfei QIAO, Hangzhou (CN); Tianhang YU, Hangzhou (CN); Hejia LUO, Hangzhou (CN); Rong LI, Boulogne Billancourt (FR)

(21) Appl. No.: 19/003,099

(22) Filed: Dec. 27, 2024

Related U.S. Application Data
(63) Continuation of application No. PCT/CN2023/097119, filed on May 30, 2023.

(30) Foreign Application Priority Data
Jun. 29, 2022 (CN) 202210759905.1

(51) Int. Cl. H04L 27/26; H04L 5/00

(52) U.S. Cl. CPC H04L 27/2618; H04L 5/0092; H04L 27/2613

(57) ABSTRACT

The disclosure includes a communication method and a communication apparatus. The communication method includes the communication apparatus determining to use a reserved tone, determining a reference signal pattern and a tone reservation (TR) pattern, and performing data transmission based on the reference signal pattern and the TR pattern. The reference signal pattern includes a first reference signal sub-pattern and a second reference signal sub-pattern, and the second reference signal sub-pattern is an offset of the first reference signal sub-pattern in time domain and/or frequency domain. According to the method, a reference signal pattern having a plurality of different sub-patterns may be provided, so that reference signals are unevenly distributed on a bandwidth. In this way, even if a reference signal density is high, a large secondary peak value of a kernel time domain signal generated on a subcarrier used as a reserved tone can be avoided, thereby improving peak-to-average power ratio (PAPR) suppression performance.

### CROSS-REFERENCE TO RELATED APPLICATIONS

This application is a continuation of International Application No. PCT/CN 2023/097119, filed on May 30, 2023, which claims priority to Chinese Patent Application No. 202210759905.1, filed on Jun. 29, 2022. The disclosures of the aforementioned applications are hereby incorporated by reference in their entireties.

### TECHNICAL FIELD

This application relates to the field of communication technologies, and in particular, to a communication method and a communication apparatus.

### BACKGROUND

A tone reservation (TR) technology can be used to suppress a peak-to-average power ratio (PAPR) of a waveform. To be specific, in addition to a subcarrier for carrying a reference signal, a transmit end further reserves some subcarriers to carry signals for PAPR suppression. The transmit end selects some subcarriers from subcarriers other than the subcarrier for carrying the reference signal as reserved tones for PAPR suppression. When a reference signal density is high, PAPR suppression performance is low.

Therefore, when the reference signal density is high, how to improve PAPR suppression performance is an urgent problem to be resolved.

### SUMMARY

This application provides a communication method and a communication apparatus, to provide a new reference signal pattern, thereby improving PAPR suppression performance through TR.

According to a first aspect, an embodiment of this application provides a communication method. The method may be performed by a communication apparatus. The communication apparatus may be a communication device or a communication apparatus, for example, a chip system, that can support the communication device in implementing a function required in the method. The following uses an example in which the communication device is a communication apparatus for description. For example, the communication apparatus is a terminal device, a chip disposed in a terminal device, or another component configured to implement a function of a terminal device. For example, the communication apparatus is a network device, a chip disposed in a network device, or another component configured to implement a function of a network device.

The communication method includes: A communication apparatus determines to use a reserved tone, determines a reference signal pattern and a TR pattern, and performs data transmission based on the reference signal pattern and the TR pattern. The reference signal pattern includes a first reference signal sub-pattern and a second reference signal sub-pattern, and the second reference signal sub-pattern is an offset of the first reference signal sub-pattern in time domain and/or frequency domain. That is, the reference signal pattern has a plurality of types of patterns, so that reference signals are unevenly distributed on a bandwidth. In this way, even if a reference signal density is high, a large secondary peak value of a kernel time domain signal generated on a subcarrier used as a reserved tone can be avoided, thereby improving PAPR suppression performance.

In a possible implementation, the method further includes: The communication apparatus determines not to use a reserved tone, where the reference signal pattern includes only the first reference signal sub-pattern. When the communication apparatus determines not to use the reserved tone, it is considered that there is no PAPR suppression requirement. In this case, the communication apparatus may determine that the reference signal pattern to be used includes only one reference signal sub-pattern, and is compatible with an existing reference signal pattern.

In a possible implementation, the bandwidth used by the communication apparatus includes G subcarrier groups, at least one subcarrier group in the G subcarrier groups uses the first reference signal sub-pattern, and at least one subcarrier group in the G subcarrier groups uses the second reference signal sub-pattern, where G is an integer greater than or equal to 2. That is, the G subcarrier groups use at least two types of reference signal sub-patterns, so that reference signals are unevenly distributed on a bandwidth. In addition, one subcarrier group corresponds to one reference signal sub-pattern, that is, a reference signal in the subcarrier group is evenly distributed, thereby ensuring decoding performance of a receive end.

In a possible implementation, the method further includes: The communication apparatus determines G based on a first density, where the first density is a reference signal density in the bandwidth used by the communication apparatus. The reference signal density is high, and the reference signal is evenly distributed on the bandwidth, which affects the PAPR suppression performance. In embodiments of this application, the communication apparatus divides the bandwidth into the G subcarrier groups properly based on the first density, to determine a reference signal sub-pattern in each subcarrier group, thereby improving the PAPR suppression performance as much as possible. The communication apparatus determines G based on the first density in the following several manners.

Determining manner 1: The communication apparatus determines G based on the first density and a first mapping relationship, where the first mapping relationship is a relationship between a quantity of subcarrier groups and a reference signal density.

Determining manner 2: The communication apparatus determines G based on the first density, a first quantity of resources, and a second mapping relationship, where the second mapping relationship is a relationship among a quantity of subcarrier groups, a reference signal density, and a quantity of resources. The first quantity of resources is a quantity of resource blocks or subcarriers included in the bandwidth used by the communication apparatus.

Determining manner 3: The communication apparatus determines G based on a first coefficient and the first density, where G is a product of the first coefficient and the first density, and the first coefficient is predefined, preconfigured, or indicated.

Determining manner 4: G is predefined, agreed on, or preconfigured.

Determining manner 1 to Determining manner 4 may reduce signaling overheads as much as possible.

In a possible implementation, the communication apparatus is a terminal device, and the method further includes: The communication apparatus receives G; or the communication apparatus receives a second quantity of resources, and determines G based on the second quantity of resources. The second quantity of resources is a quantity of resource blocks or subcarriers included in one subcarrier group. Correspondingly, the communication apparatus is a network device, and the method further includes: The communication apparatus sends G; or the communication apparatus sends a second quantity of resources, where the second quantity of resources is used to determine G. The network device configures G for the terminal device, and different G may be configured based on different requirements of different terminal devices, to optimize communication performance of each terminal device.

In a possible implementation, the method further includes: The communication apparatus determines offset information, where the offset information indicates an offset between the second reference signal sub-pattern and the first reference signal sub-pattern in time domain and/or frequency domain. Based on the first reference signal sub-pattern, the second reference signal sub-pattern may be determined by using the offset information.

In a possible implementation, that the communication apparatus determines the offset information includes: The communication apparatus determines the offset information based on group numbers of the G subcarrier groups, where an offset Δk of a start location of a reference signal in a (G_num)^{th} subcarrier group in the G subcarrier groups and G_num satisfy: Δk=mod(G_num, y) or Δk=G_num, and y is predefined or indicated, y is equal to a difference between subcarrier sequence numbers of two adjacent reference signals, or y is equal to a difference between maximum subcarrier sequence numbers of two adjacent reference signals.

In a possible implementation, an offset Δk of a start location of a reference signal in an i^{th} subcarrier group in the G subcarrier groups relative to a first subcarrier in the subcarrier group is an i^{th} value in a range of [0, y].

In a possible implementation, the communication apparatus is a terminal device, and that the communication apparatus determines the offset information includes: The communication apparatus receives the offset information. Correspondingly, the communication apparatus is a network device, and the method further includes: The communication apparatus sends the offset information. The network device provides the offset information for the terminal device, and different pieces of offset information may be configured for different terminal devices, to ensure communication performance of each terminal device as much as possible.

In a possible implementation, the communication apparatus is a terminal device, and the method further includes: The communication apparatus receives a first index, and determines G and the offset information based on the first index and a third mapping relationship. The third mapping relationship is a mapping relationship between a plurality of indexes and a plurality of groups of parameters, the plurality of indexes are in one-to-one correspondence with the plurality of groups of parameters, and one group of parameters includes one group of G and offset information. The network device indicates G and the offset information to the terminal device by using an index, so that signaling overheads can be reduced.

In a possible implementation, a subcarrier sequence number included in the reference signal pattern is determined based on the reference signal density.

In a possible implementation, the subcarrier sequence number SC_index included in the reference signal pattern satisfies:
SC_index=(2n+k)/ρ+Δk, SC_index=(2n+k)/ρ+x+Δk, SC_index=(2n+k/2)/ρ+Δk, or SC_index=(2n+k/2)/ρ+x+Δk, where ρ is the reference signal density in the bandwidth used by the communication apparatus, n=0, 1, . . . , N×ρ/2, N is the quantity of resource blocks or subcarriers included in the bandwidth used by the communication apparatus, k=0 or 1, and x is an original offset of the reference signal.

In a possible implementation, the communication apparatus is a terminal device, and that the communication apparatus determines a reserved tone includes: The communication apparatus receives indication information, where the indication information indicates that the communication apparatus uses the reserved tone. Correspondingly, the communication apparatus is a network device, and the method further includes: The communication apparatus sends indication information, where the indication information indicates that a terminal device uses the reserved tone.

According to a second aspect, an embodiment of this application provides a communication apparatus. The communication apparatus has a function of implementing behavior in the method embodiment of the first aspect. For beneficial effects, refer to the descriptions of the first aspect.

The communication apparatus may be a communication apparatus in the first aspect, or the communication apparatus may be an apparatus, for example, a chip or a chip system, that can implement the method provided in the first aspect. In a possible implementation, the communication apparatus includes a corresponding means or module configured to perform the method in the first aspect. For example, the communication apparatus includes a processing unit (sometimes also referred to as a processing module or a processor) and/or a transceiver unit (sometimes also referred to as a transceiver module or a transceiver). The transceiver unit may include a sending unit and a receiving unit, or may be understood as that the sending unit and the receiving unit are a same functional module. Alternatively, the transceiver unit is also understood as a general term of a sending unit and a receiving unit, and the sending unit and the receiving unit may be different functional modules. These units may perform a corresponding function in the method example of the first aspect. For details, refer to the detailed descriptions in the method example.

According to a third aspect, an embodiment of this application provides a communication apparatus. The communication apparatus may be the communication apparatus in the second aspect, or may be a chip or a chip system disposed in the communication apparatus in the second aspect. The communication apparatus includes a communication interface and a processor, and optionally, further includes a memory. The memory is configured to store a computer program. The processor is coupled to the memory and the communication interface. When the processor reads the computer program or instructions, the communication apparatus is enabled to perform the method performed by the communication apparatus in the foregoing method.

According to a fourth aspect, an embodiment of this application provides a communication apparatus. The communication apparatus includes an input/output interface and a logic circuit. The input/output interface is configured to input and/or output information. The logic circuit is configured to perform the method according to the first aspect.

According to a fifth aspect, an embodiment of this application provides a chip system. The chip system includes a processor, may further include a memory and/or a communication interface, and is configured to implement the method according to the first aspect. In a possible implementation, the chip system further includes the memory, configured to store a computer program. The chip system may include a chip, or may include a chip and another discrete device.

According to a sixth aspect, an embodiment of this application provides a communication system. The communication system includes a first communication apparatus and a second communication apparatus. The first communication apparatus is a terminal device, and the second communication apparatus is a network device, configured to perform the method performed by the communication apparatus in the first aspect; or the first communication apparatus is a network device, and the second communication apparatus is a terminal device, configured to perform the method performed by the communication apparatus in the first aspect. Certainly, the communication system may include more first communication apparatuses or more second communication apparatuses.

According to a seventh aspect, this application provides a computer-readable storage medium. The computer-readable storage medium stores a computer program, and when the computer program is run, the method in the first aspect is implemented.

According to an eighth aspect, a computer program product is provided. The computer program product includes computer program code. When the computer program code is run, the method in the first aspect is performed.

For beneficial effects of the second aspect to the eighth aspect and the implementations thereof, refer to the descriptions of the beneficial effects of the first aspect and the implementations thereof.

### BRIEF DESCRIPTION OF DRAWINGS

FIG. 1 is a diagram of an architecture of a communication system to which an example embodiment of this application is applicable;

FIG. 2 is a diagram of an architecture of another communication system to which an example embodiment of this application is applicable;

FIG. 3 is a diagram of a network architecture of still another communication system to which an example embodiment of this application is applicable;

FIG. 4 is a diagram of reference signal distribution with a density of ½ according to an example embodiment of this application;

FIG. 5 is a diagram of corresponding PAPR suppression performance with a reference signal density of ½ according to an example embodiment of this application;

FIG. 6 is a schematic flowchart of a communication method according to an example embodiment of this application;

FIG. 7 shows two reference signal patterns on a bandwidth used by a first communication apparatus according to an example embodiment of this application;

FIG. 8 is a diagram of distribution of a reference signal, data, and a reserved tone according to an example embodiment of this application;

FIG. 9 is a diagram of a pattern of a subcarrier and a reserved tone corresponding to a reference signal in each subcarrier group according to an example embodiment of this application;

FIG. 10 is another diagram of a pattern of a subcarrier and a reserved tone corresponding to a reference signal in each subcarrier group according to an example embodiment of this application;

FIG. 11 is a diagram of PAPR suppression performance in a same reference signal density based on a TR technology separately in cases of an even reference signal pattern and an uneven reference signal pattern according to an example embodiment of this application;

FIG. 12 is a diagram of decoding performance in a same reference signal density based on a TR technology separately in cases of an even reference signal pattern and an uneven reference signal pattern according to an example embodiment of this application;

FIG. 13 is a diagram of a reference signal pattern in a slot according to an example embodiment of this application;

FIG. 14 is a diagram of a structure of a communication apparatus according to an example embodiment of this application; and

FIG. 15 is a diagram of another structure of a communication apparatus according to an example embodiment of this application.

### DESCRIPTION OF EMBODIMENTS

Technical solutions provided in embodiments of this application may be applied to a new radio (NR) system, a Long Term Evolution (LTE) system, and a non-terrestrial network (NTN) system, or may be further applied to a next generation mobile communication system or another similar communication system. The technical solutions provided in embodiments of this application may also be applied to a vehicle to everything (V2X) system, an Internet of Things (IoT) system, and the like.

In an example, FIG. 1 is a diagram of a network architecture of a communication system to which an embodiment of this application is applicable. The communication system may include a network device and two terminal devices. The two terminal devices may be mobile terminal devices and/or any other appropriate devices configured to perform communication in a wireless communication system, and both may be connected to the network device. Both the two terminal devices can communicate with the network device. Certainly, a quantity of terminal devices in FIG. 1 is merely an example. There may be fewer or more terminal devices.

In embodiments of this application, the terminal device is a device with a wireless transceiver function, and may send a signal to the network device, or receive a signal from the network device. The terminal device may be user equipment (UE), or sometimes may be referred to as a terminal, an access station, a UE station, a remote station, a wireless communication device, a user apparatus, or the like. The terminal device is configured to connect people, things, machines, and the like, and may be widely used in various scenarios, for example, including but not limited to the following scenarios: cellular communication, device to device (D2D), V2X, machine-to-machine/machine-type communications (M2M/MTC), IoT, virtual reality (VR), augmented reality (AR), industrial control, self-driving, remote medical, a smart grid, smart furniture, smart office, smart wearables, intelligent transportation, a smart city, an uncrewed aerial vehicle, a robot, and the like.

By way of example, and not limitation, in embodiments of this application, the terminal device may alternatively be a wearable device. The wearable device may also be referred to as a wearable intelligent device, an intelligent wearable device, or the like, and is a general term of wearable devices that are intelligently designed and developed for daily wear by using a wearable technology, for example, glasses, gloves, watches, clothes, and shoes. If the various terminal devices described above are located in a vehicle (for example, placed in the vehicle or installed in the vehicle), the terminal devices may be all considered as vehicle-mounted terminal devices. For example, the vehicle-mounted terminal devices are also referred to as on-board units (OBU). The terminal device in this application may alternatively be a vehicle-mounted module, a vehicle-mounted assembly, a vehicle-mounted component, a vehicle-mounted chip, or a vehicle-mounted unit that is built in a vehicle as one or more components or units. The vehicle uses the vehicle-mounted module, the vehicle-mounted assembly, the vehicle-mounted component, the vehicle-mounted chip, or the vehicle-mounted unit that is built in the vehicle, to implement a method in this application.

In embodiments of this application, a communication apparatus configured to implement a function of the terminal device may be a terminal device, or may be an apparatus that can support the terminal device in implementing the function, for example, a chip system. The apparatus may be installed in the terminal device. In the technical solutions provided in embodiments of this application, an example in which the apparatus configured to implement the function of the terminal device is the terminal device is used to describe the technical solutions provided in embodiments of this application.

In embodiments of this application, the network device may be an access device through which the terminal device accesses a mobile communication system in a wireless manner, and includes, for example, an access network (AN) device, for example, a base station. The network device may alternatively be a device that communicates with the terminal device over an air interface. The network device may include an evolved NodeB (eNB/e-NodeB) in an LTE system or a long term evolution-advanced (LTE-A) system. The network device may alternatively include a next generation NodeB (gNB) in an NR system. The network device may alternatively include an access node or the like in a Wireless Fidelity (Wi-Fi) system. The network device may alternatively be a station, a relay station, an in-vehicle device, a future evolved public land mobile network (PLMN) device, a device in a D2D network, a device in an M2M network, a device in an Internet of Things IoT network, a network device in a PLMN network, or the like. A specific technology and a specific device form that are used by the network device are not limited in embodiments of this application.

In addition, the base station in embodiments of this application may include a central unit (CU) and a distributed unit (DU), and a plurality of DUs may be centrally controlled by one CU. The CU and the DU may be divided based on a protocol layer function that the CU and the DU each have in a wireless network. For example, functions of a packet data convergence protocol (PDCP) layer and a protocol layer above the packet data convergence protocol layer are set on the CU, and functions of protocol layers below the PDCP layer, for example, a radio link control (RLC) layer and a medium access control (MAC) layer, are set on the DU. It should be noted that division into the protocol layers is merely an example, and there may be another division of protocol layers. A radio frequency apparatus may be remotely deployed and not placed in the DU, or may be integrated into the DU, or may be partially remotely disposed and partially integrated into the DU. This is not limited in embodiments of this application. In addition, in some embodiments, a control plane (CP) and a user plane (UP) of the CU may be further separated into different entities for implementation, where the entities are respectively a control-plane CU entity (CU-CP entity) and a user-plane CU entity (CU-UP entity). The control plane CU-CP of the CU further includes a further split architecture, that is, an existing CU-CP is further split into a CU-CP 1 and a CU-CP 2. The CU-CP 1 includes various radio resource management functions, and the CU-CP 2 includes only a radio resource control (RRC) function and a PDCP-C function (that is, a basic function of control plane signaling at a PDCP layer).

In embodiments of this application, a communication apparatus configured to implement a function of a network device or a terminal device may be a network device or a terminal device, or may be an apparatus that can support the network device or the terminal device in implementing the function, for example, a chip system. The apparatus may be installed in the network device or the terminal device. In the technical solutions provided in embodiments of this application, an example in which an apparatus configured to implement the function of the network device is a network device, and an apparatus configured to implement the function of the terminal device is a terminal device is used to describe the technical solutions provided in embodiments of this application.

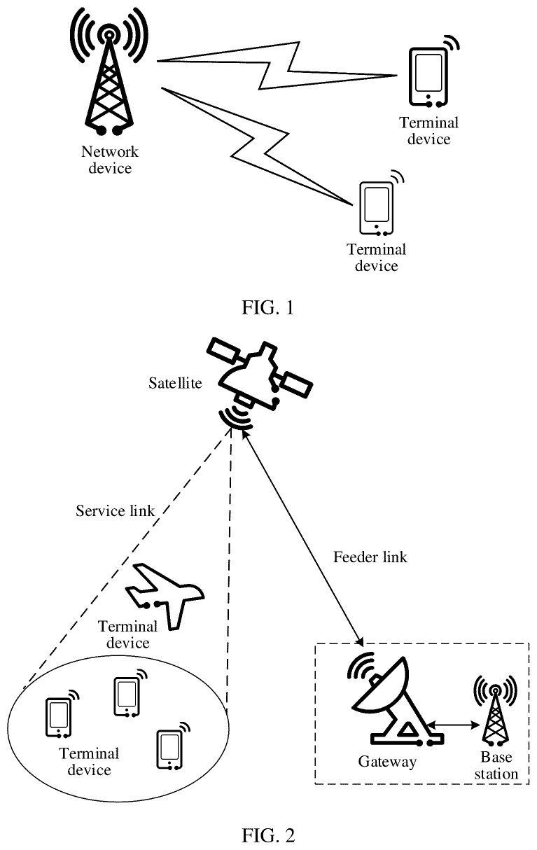

In another example, FIG. 2 is a diagram of a network architecture of another communication system to which an embodiment of this application is applicable. The communication system includes a satellite, terminal devices, and a gateway. The satellite may be a highly elliptical orbiting (HEO) satellite, a geosynchronous earth orbit (GEO) satellite, a medium earth orbit (MEO) satellite, and a low-earth orbit (LEO) satellite. In addition, an NTN system may further include a high altitude platform station (HAPS) and the like. This is not limited herein. The gateway (or referred to as a ground station, an earth station, a gateway station, or a gateway station) may be used to connect a satellite and a terrestrial base station gateway station/gateway station. One or more satellites may be connected to one or more terrestrial base stations via one or more gateways. This is not limited herein. The terminal devices include, for example, mobile phones, an airplane, and the like (these are used as examples in FIG. 2). A link between the satellite and the terminal device is referred to as a service link, and a link between the satellite and the gateway is referred to as a feeder link.

An operating mode of the satellite is not limited in embodiments of this application. For example, the operating mode of the satellite may be a transparent transmission mode, or a regenerative mode.

In the transparent transmission mode, the satellite, as an analog radio frequency repeater, has a relay forwarding function, can implement radio frequency conversion and amplification, and can transparently transmit or copy a signal between the base station and the terminal device. For example, a signal sent by the terminal device may be transparently transmitted via the satellite and forwarded by the gateway to the terrestrial base station. The gateway has some or all functions of a base station. In this case, the gateway may be considered as a base station. It may be considered that a network element and the base station may be deployed together or separately. If the gateway and the base station are separately deployed, a delay of the feeder link includes a delay from the satellite to the gateway and a delay from the gateway to the base station.

In the regenerative mode, the satellite, as a base station for wireless communication, has some or all functions of the base station, implements regeneration of signals received from the ground, and may understand and process these signals. For example, the satellite may be a base station carried on an artificial earth satellite or a high-altitude aircraft. For example, the base station may be an evolved NodeB (eNB) or a 5G base station (gNB). The gateway may forward signaling between the satellite (namely, the base station) and a core network.

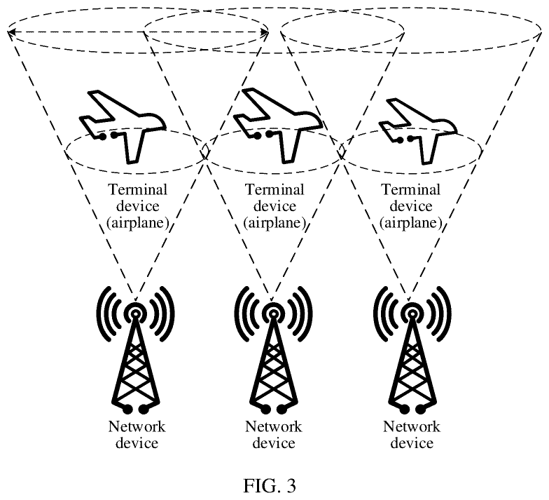

It may be understood that embodiments of this application are also applicable to an air-to-ground (ATG) communication system. For example, FIG. 3 is a diagram of a network architecture of still another communication system to which an embodiment of this application is applicable. The communication system includes at least one network device and at least one high-altitude terminal device, like a high-altitude airplane and an on-board terminal device.

In embodiments of this application, unless otherwise specified, a quantity of a noun indicates “a singular noun or a plural noun”, namely, “one or more”. “At least one” means one or more, and “a plurality of” means two or more. “And/or” describes an association relationship between associated objects and indicates that at least three relationships may exist. For example, A and/or B may indicate the following three cases: Only A exists, both A and B exist, and only B exists, where A and B may be singular or plural. A character “/” generally indicates an “or” relationship between the associated objects. For example, A/B indicates A or B. “At least one item (piece) of the following” or a similar expression thereof means any combination of these items, including a singular item (piece) or any combination of plural items (pieces). For example, at least one of a, b, or c indicates a, b, c, a and b, a and c, b and c, or a, b, and c, where a, b, and c may be singular or plural.

Ordinal numerals such as “first” and “second” in embodiments of this application are used to distinguish between a plurality of objects, and are not intended to limit sizes, content, a sequence, a time sequence, application scenarios, priorities, or importance of the plurality of objects. For example, “first reference signal sub-pattern” and “second reference signal sub-pattern” indicate that there are two sub-patterns, but do not indicate that the two sub-patterns have different priorities, importance degrees, or the like.

The foregoing describes the communication systems to which embodiments of this application are applicable. The following describes related technical content mainly related to embodiments of this application.

A satellite data processing capability and transmit power of a satellite device are limited due to manufacturing and transmission costs. Specifically, the satellite device is an energy-limited and power-limited device, and is sensitive to satellite power efficiency, that is, power efficiency of the satellite device is expected to be improved as much as possible. In both terrestrial cellular network communication and NTN communication, it is required that a high power amplifier (HPA) at a transmit end operate near a linear saturation region, to improve power efficiency of the HPA.

If a system performs data transmission through an orthogonal frequency division multiplexing (OFDM) waveform or a waveform with a high PAPR characteristic, a high PAPR occurs. Because a PAPR of an OFDM signal is high, when the HPA operates near a saturation point, there is a specific probability that the signal input to the HPA enters a non-linear region, and non-linear distortion is generated. Non-linear distortion introduces in-band distortion and out-of-band radiation, which affects decoding accuracy of a receive end and causes interference to a user on an adjacent channel. Therefore, power back-off can be performed on the signal input to the HPA to minimize non-linear distortion of the HPA. Performing power back-off on the signal input to the HPA may be understood as reducing power of the signal input to the HPA. Although power back-off performed on the signal input to the HPA may reduce non-linear distortion of the HPA, power of a signal output by the HPA is reduced. This reduces transmit power and power efficiency of the HPA, and further reduces signal received power of the receive end and reduces a signal-to-noise ratio of the receive end. Therefore, a TR technology is proposed to suppress the PAPR corresponding to the OFDM waveform. The TR technology may be understood as that some reserved tones are reserved as carriers for PAPR suppression. The reserved tones for PAPR suppression may include a plurality of subcarriers, which are also referred to as a carrier set. A pattern formed by subcarrier numbers corresponding to the subcarriers included in the carrier set is referred to as a TR pattern. That is, a TR pattern may indicate a set of reserved tones for PAPR suppression.

Suppressing the PAPR by using the TR technology means that a reserved tone for PAPR suppression is reserved at a transmit end to carry a signal for PAPR suppression, and some carriers other than the reserved tone are used to carry a data signal and a reference signal. Certainly, to improve spectral efficiency, a data signal may also be carried on the reserved tone, that is, the reserved tone may carry both the signal for PAPR suppression and the data signal. Optionally, the carrier set carrying the signals for PAPR suppression does not overlap a carrier set carrying the data signal and the reference signal (this is used as an example in this specification). When demodulating information received from the transmit end, the receive end may skip or remove the reserved tone for PAPR suppression, that is, not decode a signal on the reserved tone for PAPR suppression. Specifically, the transmit end generates, by using the reserved tone, a normalized kernel time domain signal to suppress a PAPR of an OFDM waveform, that is, the kernel signal occupies only the reserved tone in frequency domain. When the PAPR is specifically suppressed, a kernel time domain signal on which cyclic shift, phase rotation, and scale transformation are performed is subtracted from OFDM time domain data, to obtain an OFDM time domain signal that completes one PAPR suppression iteration. The iteration is continued subsequently, and a principle of PAPR suppression based on the TR pattern is the conventional technology.

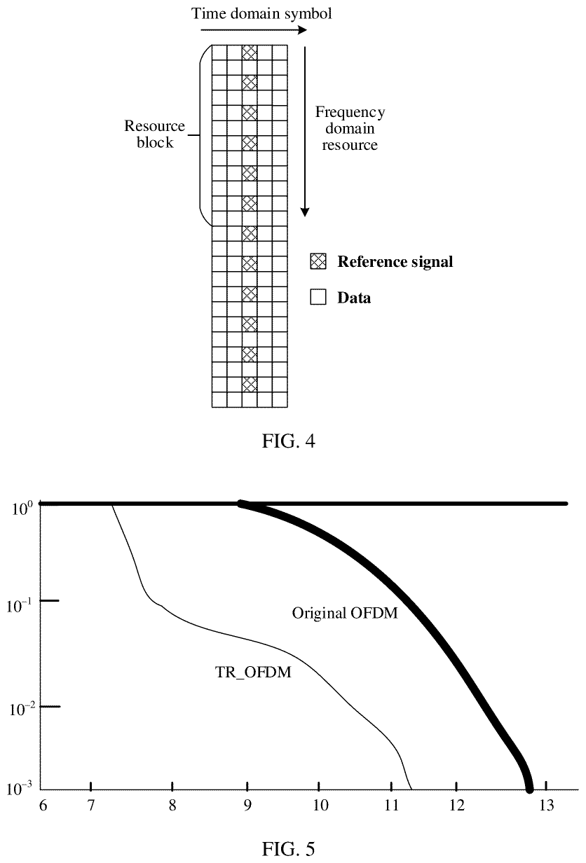

The transmit end selects some subcarriers from subcarriers other than a subcarrier for carrying a reference signal as reserved tones. If a reference signal density is high, PAPR suppression performance is low. For example, it is assumed that the reference signal is evenly distributed, and it may also be considered that the reference signal has only one type of sub-pattern. When the reference signal density is high, the PAPR suppression performance is low. For example, FIG. 4 is a diagram of distribution of a reference signal with a density of ½. It is assumed that a sequence number of the reference signal starts from a 1^{st} subcarrier of an allocated resource block (RB). For example, a number of a 1^{st} subcarrier starts from 0. It is assumed that the reference signal is evenly distributed, sequence numbers of reference signals are 0, 2, 4, 6, 8, . . . , and the like, and the reserved tone may be selected from only subcarriers with sequence numbers of 1, 3, 5, 7, 9, . . . , and the like. Correspondingly, some subcarriers are selected from the subcarriers with sequence numbers of 1, 3, 5, 7, 9, . . . , and the like as reserved tones to suppress the PAPR. The kernel time domain signal generated by using the reserved tone may have a plurality of peak values, and a secondary peak value is large. In this way, after the kernel time domain signal on which cyclic shift and the like are performed is subtracted from the OFDM time domain data, a large secondary peak value still exists, that is, the PAPR suppression performance is low, as shown in FIG. 5. FIG. 5 is a diagram of corresponding PAPR suppression performance with a reference signal density of ½. In FIG. 5, a thick line indicates suppression performance obtained when the reserved tone is not used to suppress the PAPR, and a thin line indicates suppression performance obtained when the reserved tone is used to suppress the PAPR.

In view of this, the solutions in embodiments of this application are provided. Embodiments of this application include at least two types of reference signal sub-patterns. It may also be considered that the reference signals are unevenly distributed on a bandwidth, so that a large secondary peak value of a kernel time domain signal generated by using a subcarrier used as the reserved tone can be avoided, thereby improving the PAPR suppression performance.

The technical solutions provided in embodiments of this application are described below in detail with reference to the accompanying drawings.

Embodiments of this application provide a communication method. The method is applied to any communication system, provided that a transmit end communicates with a receive end. In the following descriptions, the communication method is applied to any communication system shown in FIG. 1 to FIG. 3. The communication method provided in embodiments of this application is applied to uplink transmission, or applied to downlink transmission. It should be understood that uplink transmission and downlink transmission are relative. For example, transmission from a first communication apparatus to a second communication apparatus is the uplink transmission, and transmission from the second communication apparatus to the first communication apparatus is the downlink transmission. Embodiments of this application are not limited to performing data transmission through an OFDM waveform. For example, data transmission may be performed through a DFT-S-OFDM waveform. That is, DFT precoding is first performed on data, and then data obtained by precoding is mapped to a frequency domain data subcarrier. Unless otherwise specified, “carrier bandwidth” and “system bandwidth” in the following sections are interchangeable. A quantity of resources includes a quantity of frequency domain resources, and refers to a quantity of resource units. A granularity of a resource unit is not limited in embodiments of this application. For example, the resource unit may be an RB, a subcarrier, a resource element (RE), or an RB group. A quantity of RBs included in one RB group is not limited. For example, one RB group includes six RBs. For example, the quantity of resources may be a quantity of RBs included in the bandwidth, or may be a quantity of subcarriers included in the bandwidth. A type of the reference signal is not limited in embodiments of this application. For example, the reference signal may be a phase tracking reference signal (PTRS), a demodulation reference signal (DMRS), a channel state information-reference signal (CSI-RS), a tracking reference signal (TRS), or a sounding reference signal (SRS). In the following descriptions, “when” and “in a case of” belong to a same concept, and may be interchangeable unless otherwise specified. In this specification, mod(a,b) represents a mod operation, that is, a modulo operation, and represents a modulo operation of a on b.

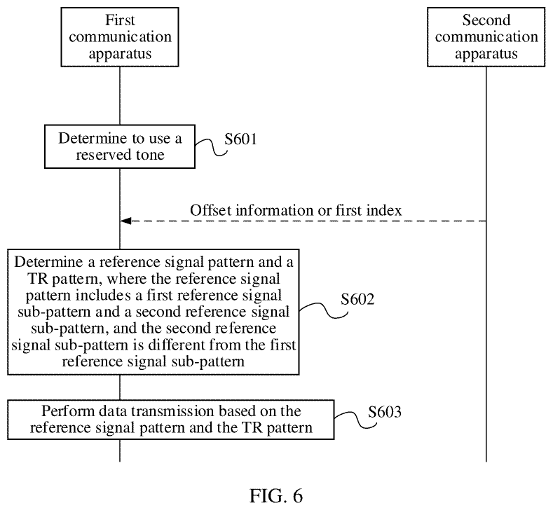

FIG. 6 is a schematic flowchart of a communication method according to an embodiment of this application. In the following descriptions, an example in which the communication method is performed by using a first communication apparatus and a second communication apparatus is used. The first communication apparatus may be a terminal device, and the second communication apparatus may be a network device; or the first communication apparatus is a network device, and the second communication apparatus is a terminal device. A dashed-line step in FIG. 6 indicates that the step is optional, that is, the step is not a necessary step.

S601: A first communication apparatus determines to use a reserved tone.

That a first communication apparatus determines to use a reserved tone includes: the first communication apparatus determines that the first communication apparatus uses the reserved tone, and/or the first communication apparatus determines that the second communication apparatus uses the reserved tone. The first communication apparatus may determine, by itself, whether to use the reserved tone, or may determine, based on an indication of the second communication apparatus, whether the first communication apparatus uses the reserved tone.

For example, the first communication apparatus may determine, based on a performance requirement of the first communication apparatus for PAPR suppression, whether the first communication apparatus uses the reserved tone. For example, if the first communication apparatus has a low performance requirement for PAPR suppression, the first communication apparatus may determine that the first communication apparatus does not use the reserved tone; and if the first communication apparatus has a high performance requirement for PAPR suppression, the first communication apparatus may determine that the first communication apparatus uses the reserved tone.

For another example, the first communication apparatus may determine, based on the indication of the second communication apparatus, whether to use the reserved tone. For example, the first communication apparatus is a terminal device, and the second communication apparatus is a network device. The second communication apparatus may send indication information to the first communication apparatus, where the indication information indicates that the first communication apparatus uses the reserved tone. The first communication apparatus receives the indication information, and determines that the first communication apparatus uses the reserved tone. If the first communication apparatus does not receive the indication information, it may be considered that the first communication apparatus does not need to use the reserved tone. Alternatively, the second communication apparatus may send indication information to the first communication apparatus, where the indication information indicates whether the first communication apparatus uses the reserved tone. The first communication apparatus receives the indication information. If the indication information indicates that the first communication apparatus does not use the reserved tone, the first communication apparatus determines not to use the reserved tone when sending a signal to the second communication apparatus. If the indication information indicates that the first communication apparatus uses the reserved tone, the first communication apparatus determines to use the reserved tone when sending a signal to the second communication apparatus.

For still another example, the first communication apparatus may determine, based on a to-be-used TR pattern indicated by the second communication apparatus, whether to use the reserved tone. In other words, the second communication apparatus may indirectly indicate, by indicating the TR pattern, whether the first communication apparatus uses the reserved tone. If the to-be-used TR pattern indicated by the second communication apparatus to the first communication apparatus is used when the second communication apparatus sends a signal to the first communication apparatus, or the to-be-used TR pattern indicated by the second communication apparatus to the first communication apparatus is used when the first communication apparatus receives a signal sent by the second communication apparatus, the first communication apparatus may determine that the second communication apparatus uses the reserved tone when sending a signal to the first communication apparatus, and the first communication apparatus needs to use the reserved tone to receive the signal sent by the second communication apparatus. If the second communication apparatus does not indicate the to-be-used TR pattern to the first communication apparatus, the first communication apparatus may determine that the second communication apparatus does not use the reserved tone when sending a signal to the first communication apparatus, and the first communication apparatus does not need to use the reserved tone to receive the signal sent by the second communication apparatus. If the to-be-used TR pattern indicated by the second communication apparatus to the first communication apparatus is used when the first communication apparatus sends a signal to the second communication apparatus, or the to-be-used TR pattern indicated by the second communication apparatus to the first communication apparatus is used when the second communication apparatus receives a signal sent by the first communication apparatus, the first communication apparatus may determine that the first communication apparatus uses the reserved tone when sending a signal to the second communication apparatus. If the second communication apparatus does not indicate the to-be-used TR pattern to the first communication apparatus, the first communication apparatus may determine that the first communication apparatus does not use the reserved tone when sending a signal to the second communication apparatus.

Similarly, the first communication apparatus may determine, based on a performance requirement of the second communication apparatus for PAPR suppression or the indication of the second communication apparatus, whether the second communication apparatus uses the reserved tone. For example, the first communication apparatus is a terminal device, and the second communication apparatus is a network device. The second communication apparatus may send indication information to the first communication apparatus, where the indication information indicates the performance requirement of the second communication apparatus for PAPR suppression or indicates whether the second communication apparatus uses the reserved tone. The first communication apparatus receives the indication information, and may determine, based on the indication information, whether the second communication apparatus uses the reserved tone. If the indication information indicates that the second communication apparatus has a low performance requirement for PAPR suppression or indicates that the second communication apparatus does not use the reserved tone, the first communication apparatus determines that the second communication apparatus does not use the reserved tone when sending a signal to the first communication apparatus; and if the indication information indicates that the second communication apparatus has a high performance requirement for PAPR suppression or indicates that the second communication apparatus uses the reserved tone, the first communication apparatus determines that the second communication apparatus uses the reserved tone when sending a signal to the first communication apparatus.

S602: The first communication apparatus determines a reference signal pattern and the TR pattern, where the reference signal pattern includes a first reference signal sub-pattern and a second reference signal sub-pattern, and the second reference signal sub-pattern is different from the first reference signal sub-pattern.

The reference signal pattern is a pattern of a reference signal in a bandwidth used by the first communication apparatus. In this embodiment of this application, the reference signal pattern may include at least one reference signal sub-pattern. For example, the reference signal pattern may include only the first reference signal sub-pattern, that is, there is only one type of reference signal pattern. The reference signal pattern may also include at least two sub-patterns, and the at least two sub-patterns include at least two types of sub-patterns. In other words, there may be a plurality of types of reference signal patterns. For example, the reference signal pattern includes a first reference signal sub-pattern and a second reference signal sub-pattern, and the first reference signal sub-pattern is different from the second reference signal sub-pattern. For another example, the reference signal pattern includes three different sub-patterns: a first reference signal sub-pattern, a second reference signal sub-pattern, and a third reference signal sub-pattern, and the first reference signal sub-pattern, the second reference signal sub-pattern, and the third reference signal sub-pattern are all different.

That sub-patterns of two types of reference signals are different indicates that the two types of reference signals occupy subcarriers with different sequence numbers and/or occupy different quantities of subcarriers. For example, the first reference signal sub-pattern is different from the second reference signal sub-pattern, and a sequence number and/or a quantity of subcarriers occupied by a reference signal in the first reference signal sub-pattern is different from those in the second reference signal sub-pattern. That sub-patterns of two types of reference signals are different may also be understood as that one reference signal sub-pattern is an offset of the other reference signal sub-pattern in time domain and/or frequency domain. For example, the first reference signal sub-pattern is different from the second reference signal sub-pattern, and the first reference signal sub-pattern is an offset of the second reference signal sub-pattern in time domain and/or frequency domain.

Results that the first communication apparatus determines whether to use the reserved tone are different, and therefore, reference signal patterns selected by the first communication apparatus are also different. For example, if the first communication apparatus determines not to use the reserved tone, it may be determined that there is only one type of reference signal pattern. For example, the reference signal pattern includes only the first reference signal sub-pattern; and if the first communication apparatus determines to use the reserved tone, it may be determined that there are at least two types of reference signal patterns. For example, the reference signal patterns may include the first reference signal sub-pattern and the second reference signal sub-pattern.

A frequency domain resource (for example, referred to as a first frequency domain resource) corresponding to the first reference signal sub-pattern may be adjacent to or not adjacent to a frequency domain resource (for example, referred to as a second frequency domain resource) corresponding to the second reference signal sub-pattern. It may also be understood that a pattern of a reference signal on the first frequency domain resource is the first reference signal sub-pattern, a pattern of a reference signal on the second frequency domain resource is the second reference signal sub-pattern, and the first frequency domain resource may be adjacent to or not adjacent to the second frequency domain resource. For ease of description, in the following descriptions, a frequency domain resource corresponding to one reference signal sub-pattern is referred to as a group of frequency domain resources. A group of frequency domain resources may be a group of subcarriers. For example, the bandwidth used by the first communication apparatus includes G subcarrier groups, where G is an integer greater than or equal to 2. Correspondingly, when the first communication apparatus determines not to use the reserved tone, each subcarrier in the G subcarrier groups uses the first reference signal sub-pattern. When the first communication apparatus determines to use the reserved tone, at least one subcarrier group in the G subcarrier groups uses the first reference signal sub-pattern, and at least one subcarrier group in the G subcarrier groups uses the second reference signal sub-pattern. Reference signal sub-patterns corresponding to two adjacent subcarrier groups in the G subcarrier groups may be the same or different. Implementation forms of the first reference signal sub-pattern and the second reference signal sub-pattern are described in the following.

The first communication apparatus determines G, that is, determines a quantity of subcarrier groups included in the bandwidth used by the first communication apparatus. The first communication apparatus determines G in a plurality of manners.

Determining manner 1: G may be predefined or preconfigured, or G is agreed on by the first communication apparatus and the second communication apparatus. In this manner, the first communication apparatus may determine G without signaling exchange with the second communication apparatus, so that signaling overheads can be reduced.

Determining manner 2: The first communication apparatus determines G based on a reference signal density (for example, referred to as a first density) of the bandwidth used by the first communication apparatus, which specifically includes the following cases.

Case 1: The first communication apparatus may determine G based on the first density and a first mapping relationship, where the first mapping relationship is a relationship between a quantity of subcarrier groups and a reference signal density.

For example, Table 1 shows the relationship between a quantity of subcarrier groups and a reference signal density. The first communication apparatus may determine G based on Table 1 and the first density. For example, the first density is ½, and G is 4; and the first density is ⅓, and G is 3.

TABLE 1

| Reference signal density | Quantity G of subcarrier groups |
|---|---|
| 1/2 | 4 |
| 1/3 | 3 |
| 1/4 | 2 |

A correspondence between a reference signal density and G in Table 1 is merely an example. A value of the reference signal density and a value of G in Table 1 are not limited in this embodiment of this application. Table 1 may be predefined or preconfigured, or may be agreed on by the first communication apparatus and the second communication apparatus; or Table 1 may be configured by the second communication apparatus for the first communication apparatus, and is more flexible. For example, the first communication apparatus is a terminal device, and the second communication apparatus is a network device. The second communication apparatus may send configuration information to the first communication apparatus, and the configuration information may indicate the first mapping relationship. Optionally, G corresponding to a reference signal density may be 0 or 1, that is, the bandwidth used by the first communication apparatus is not divided into a plurality of subcarrier groups. Optionally, if G corresponding to a reference signal density is not agreed on, G of the reference signal density is considered as a preset value or a default value by default, for example, 0, 2, 3, 4, or 6.

Case 2: The first communication apparatus may determine G based on the first density, a first quantity of resources, and a second mapping relationship, where the second mapping relationship is a relationship among a quantity of subcarrier groups, a reference signal density, and a quantity of resources. The first quantity of resources is a quantity of resource blocks or subcarriers included in the bandwidth used by the first communication apparatus.

For example, Table 2 shows a relationship among a quantity of subcarrier groups, a reference signal density, and a quantity of RBs. The first communication apparatus may determine G based on Table 2, the first density, and the first quantity of resources. For example, the first density is ½, the quantity of RBs is 66, and G is 4; and the first density is ½, the quantity of RBs is 132, and G is 6.

TABLE 2

| Quantity of RBs | Reference signal density | Quantity G of subcarrier groups |
|---|---|---|
| 66 | 1/2 | 4 |
| 66 | 1/3 | 3 |
| 66 | 1/4 | 2 |
| 132 | 1/2 | 6 |
| 132 | 1/3 | 4 |
| 132 | 1/4 | 3 |

A correspondence among a reference signal density, a quantity of RBs, and G in Table 2 is merely an example. A value of the reference signal density, the quantity of RBs, and a value of G in Table 2 are not limited in this embodiment of this application. Table 2 may be predefined or preconfigured, or may be agreed on by the first communication apparatus and the second communication apparatus; or Table 2 may be configured by the second communication apparatus for the first communication apparatus, and is more flexible. For example, the first communication apparatus is a terminal device, and the second communication apparatus is a network device. The second communication apparatus may send configuration information to the first communication apparatus, and the configuration information may indicate the second mapping relationship. Optionally, G corresponding to a reference signal density may be 0 or 1, that is, the bandwidth used by the first communication apparatus is not divided into a plurality of subcarrier groups. Optionally, if G corresponding to a reference signal density is not agreed on, G of the reference signal density is considered as a preset value or a default value by default, for example, 0, 2, 3, 4, or 6.

Case 3: The communication apparatus determines G based on a first coefficient and the first density, where G is a product of the first coefficient and the first density, and the first coefficient is predefined, preconfigured, or indicated. For example, G satisfies: G=s×RS_density, where s is the first coefficient, and RS_density is the first density. s may be predefined, preconfigured, or agreed on by the first communication apparatus and the second communication apparatus, or provided by the second communication apparatus for the first communication apparatus. For example, the first communication apparatus is a terminal device, the second communication apparatus is a network device, and the second communication apparatus may send indication information to the first communication apparatus, where the indication information includes s.

In Determining manner 2, the first communication apparatus may determine G based on the first density, and may determine a proper G as much as possible, to improve PAPR suppression performance.

Determining manner 3: The first communication apparatus determines G based on the indication of the second communication apparatus, which specifically includes the following cases.

Case 1: The second communication apparatus provides G for the first communication apparatus. For example, the first communication apparatus is a terminal device, and the second communication apparatus is a network device. The second communication apparatus may send indication information to the first communication apparatus, and the indication information may indicate G. The first communication apparatus receives the indication information sent by the second communication apparatus, and determines G based on the indication information.

For example, the indication information may include G; or the indication information may include a first index. The first communication apparatus determines G based on the first index and a correspondence between a quantity of subcarrier groups and an index. For example, Table 3 shows a correspondence between a quantity of subcarrier groups and an index. The second communication apparatus provides G for the first communication apparatus by using the first index, so that signaling overheads can be reduced.

TABLE 3

| Index | Quantity G of |
|---|---|
| number | subcarrier groups |
| 0 | 4 |
| 1 | 6 |
| 2 | 8 |
| 3 | 16 |
| 4 | 24 |
| . . . | . . . |

Table 3 may be predefined or preconfigured, or may be agreed on by the first communication apparatus and the second communication apparatus; or Table 3 may be configured by the second communication apparatus for the first communication apparatus, and is more flexible. For example, the first communication apparatus is a terminal device, and the second communication apparatus is a network device. The second communication apparatus may send configuration information to the first communication apparatus, and the configuration information may indicate a correspondence between a subcarrier group and an index.

Case 2: The second communication apparatus sends a second quantity of resources to the first communication apparatus, where the second quantity of resources is a quantity of RBs or subcarriers included in one subcarrier group. The first communication apparatus determines G based on the second quantity of resources. For example, the first communication apparatus may determine that G is a ratio of a quantity of resources included in the bandwidth used by the first communication apparatus to the second quantity of resources.

Reference signal sub-patterns in different subcarrier groups may be the same or different. For example, G subcarrier groups include a first subcarrier group and a second subcarrier group that are adjacent to each other, the first subcarrier group uses a first reference signal sub-pattern, and the second subcarrier group uses a second reference signal sub-pattern. For another example, G subcarrier groups include a first subcarrier group, a second subcarrier group, a third subcarrier group, and a fourth subcarrier group that are successively adjacent to each other. The first subcarrier group uses a first reference signal sub-pattern, the second subcarrier group uses a second reference signal sub-pattern, the third subcarrier group uses a first reference signal sub-pattern, and the fourth subcarrier group uses a second reference signal sub-pattern. Alternatively, the first subcarrier group uses a first reference signal sub-pattern, the second subcarrier group uses a second reference signal sub-pattern, the third subcarrier group uses a second reference signal sub-pattern, and the fourth subcarrier group uses a first reference signal sub-pattern. Because the second reference signal sub-pattern is different from the first reference signal sub-pattern, it may be considered that the bandwidth used by the first communication apparatus includes at least two types of reference signal patterns. For example, the first communication apparatus may determine, by determining an offset between the second reference signal sub-pattern and the first reference signal sub-pattern in time domain and/or frequency domain, a reference signal pattern on the bandwidth used by the first communication apparatus.

The offset between the second reference signal sub-pattern and the first reference signal sub-pattern in frequency domain is an offset between a sequence number of a 1^{st} subcarrier in a subcarrier group corresponding to the second reference signal sub-pattern and a sequence number of a 1^{st} subcarrier in a subcarrier group corresponding to the first reference signal sub-pattern. The first communication apparatus determines the offset between the second reference signal sub-pattern and the first reference signal sub-pattern in frequency domain in a plurality of determining manners below.

Determining manner 1: The second communication apparatus may indicate, to the first communication apparatus, the offset between the second reference signal sub-pattern and the first reference signal sub-pattern in frequency domain. For example, the first communication apparatus is a terminal device, and the second communication apparatus is a network device. The second communication apparatus may send offset information to the first communication apparatus. Correspondingly, the first communication apparatus receives the offset information sent by the second communication apparatus, and the offset information indicates the offset between the second reference signal sub-pattern and the first reference signal sub-pattern in frequency domain, as shown in FIG. 6. It should be understood that the second communication apparatus may not send the offset information to the first communication apparatus. In this case, a dashed line is used for illustration in FIG. 6.

For example, there are G subcarrier groups, and a subcarrier group corresponding to the first reference signal sub-pattern is a 1^{st} subcarrier group in the G subcarrier groups. The offset information may indicate an offset between a reference signal sub-pattern used by each subcarrier group in the G subcarrier groups and the first reference signal sub-pattern in frequency domain. For example, G=4, and the offset information may indicate “0,1,0,1”. To be specific, an offset between a reference signal sub-pattern used by a 1^{st} subcarrier group and the first reference signal sub-pattern in frequency domain is 0, an offset between a reference signal sub-pattern used by a 1^{st} subcarrier group and the first reference signal sub-pattern in frequency domain is 1, an offset between a reference signal sub-pattern used by a 1^{st} subcarrier group and the first reference signal sub-pattern in frequency domain is 0, and an offset between a reference signal sub-pattern used by a 1^{st} subcarrier group and the first reference signal sub-pattern in frequency domain is 1. For another example, G=6, and the offset information may indicate “0, 1, 2, 0, 1, 2”.

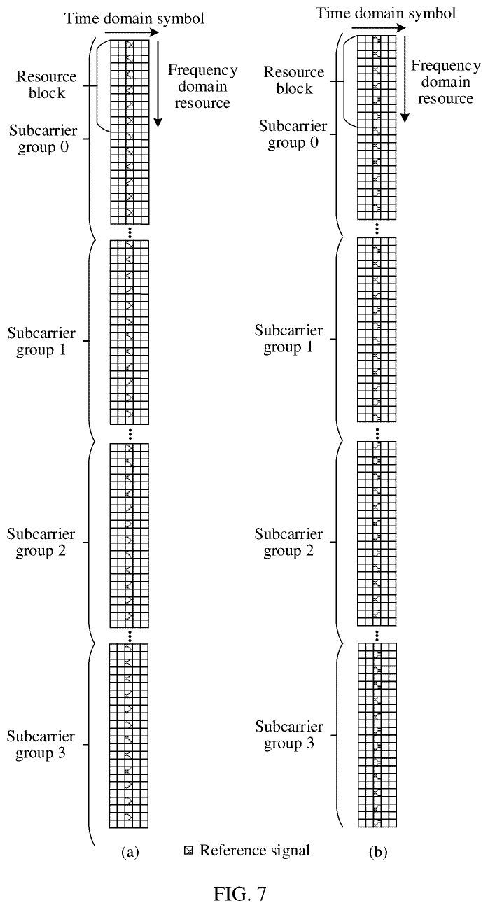

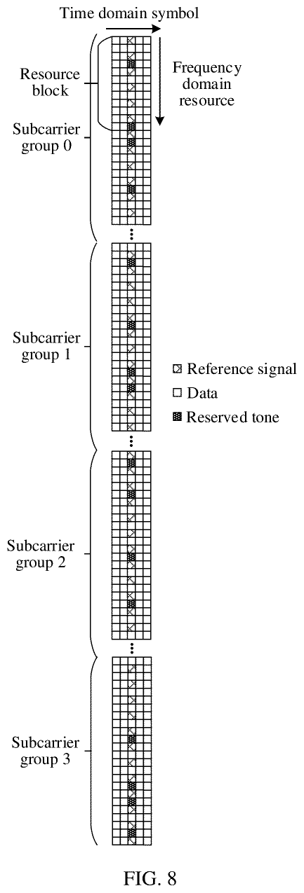

For ease of understanding, FIG. 7 shows two types of reference signal patterns on a bandwidth used by a first communication apparatus. FIG. 7 uses a reference signal pattern on one symbol as an example, and uses an example in which the bandwidth used by the first communication apparatus includes four subcarrier groups, and the reference signal density is ½. As shown in (a) in FIG. 7, the first reference signal sub-pattern is a reference signal pattern on subcarrier group 0, and all offsets between reference signal sub-patterns respectively used by subcarrier group 1 to subcarrier group 3 and the first reference signal sub-pattern in frequency domain are 0. However, in this embodiment of this application, as shown in (b) in FIG. 7, the first reference signal sub-pattern is the reference signal pattern on subcarrier group 0, the offset between the reference signal sub-pattern used by subcarrier group 1 and the first reference signal sub-pattern in frequency domain is 1, the offset between the reference signal sub-pattern used by subcarrier group 2 and the first reference signal sub-pattern in frequency domain is 0, and the offset between the reference signal sub-pattern used by subcarrier group 3 and the first reference signal sub-pattern in frequency domain is 1. It can be learned from (b) in FIG. 7 that, in this embodiment of this application, the bandwidth used by the first communication apparatus may include two types of reference signal patterns, and the first communication apparatus may select, from subcarriers other than a subcarrier for carrying a reference signal, a subcarrier used as a reserved tone, to improve PAPR suppression performance. For example, FIG. 8 is a diagram of distribution of a reference signal, data, and a reserved tone. In FIG. 8, an example in which the reference signal pattern is (b) in FIG. 7 is used.

In a possible implementation, a mapping relationship between a quantity of subcarrier groups and offset information may be predefined or preconfigured, or may be agreed on by the first communication apparatus and the second communication apparatus. The first communication apparatus determines the quantity of subcarrier groups, and determines the offset information based on the mapping relationship. For example, Table 4 shows a mapping relationship between a quantity of subcarrier groups and offset information.

TABLE 4

| Quantity G | Offset Δk between a reference signal |
|---|---|
| of subcarrier | sub-pattern used by each subcarrier group |
| groups | and a first reference signal sub-pattern |
| 4 | 0, 1, 0, 1 |
| 6 | 0, 1, 2, 0, 1, 2 |
| 8 | 0, 1, 0, 1, 0, 1, 0, 1 |
| 16 | 0, 1, 2, 3, 0, 1, 2, 3, 0, 1, 2, 3, 0, 1, 2, 3 |
| 24 | 0, 1, 2, 3, 0, 1, 2, 3, 0, 1, 2, 3, |
| | 0, 1, 2, 3, 0, 1, 2, 3, 0, 1, 2, 3, |
| . . . | . . . |

Optionally, Table 4 is configured by the second communication apparatus for the first communication apparatus, and is more flexible. For example, the first communication apparatus is a terminal device, and the second communication apparatus is a network device. The second communication apparatus may send configuration information to the first communication apparatus. The configuration information may indicate a mapping relationship between a quantity of subcarrier groups and offset information, and is more flexible.

In a possible implementation, a third mapping relationship, for example, a mapping relationship among an index, a quantity of subcarrier groups, and offset information, may be predefined or preconfigured, or may be agreed on by the first communication apparatus and the second communication apparatus. The quantity of subcarrier groups and the offset information are used as a group of parameters, or it may be considered that the third mapping relationship may be a mapping relationship between a plurality of indexes and a plurality of groups of parameters. One index corresponds to one group of parameters. For example, Table 5 shows the third mapping relationship.

TABLE 5

| | Quantity G | Offset Δk between a reference signal |
|---|---|---|
| | of subcarrier | sub-pattern used by each subcarrier group |
| Index | groups | and a first reference signal sub-pattern |
| 0 | 4 | 0, 1, 0, 1 |
| 1 | 6 | 0, 1, 2, 0, 1, 2 |
| 2 | 8 | 0, 1, 0, 1, 0, 1, 0, 1 |
| 3 | 16 | 0, 1, 2, 3, 0, 1, 2, 3, 0, 1, 2, 3, 0, 1, 2, 3 |
| 4 | 24 | 0, 1, 2, 3, 0, 1, 2, 3, 0, 1, 2, 3, |
| | | 0, 1, 2, 3, 0, 1, 2, 3, 0, 1, 2, 3, |
| . . . | . . . | . . . |

In this case, the second communication apparatus may indicate the quantity of subcarrier groups and the offset information by sending the first index to the first communication apparatus, thereby reducing signaling overheads. Optionally, Table 5 is configured by the second communication apparatus for the first communication apparatus, and is more flexible. For example, the first communication apparatus is a terminal device, and the second communication apparatus is a network device. The second communication apparatus may send configuration information to the first communication apparatus. The configuration information may indicate the third mapping relationship, and this is more flexible. It should be understood that the second communication apparatus may not send the first index to the first communication apparatus. In this case, a dashed line is used for illustration in FIG. 6.

Determining manner 2: The first communication apparatus determines the offset information based on group numbers of the G subcarrier groups.

For example, an offset Δk of a start location of a reference signal in a (G_num)^{th} subcarrier group of the G subcarrier groups and G_num satisfy: Δk=mod(G_num, y1), G_num=0, 1, 2, . . . , G−1; or Δk=mod(G_num−1, y1), G_num=1, 2, . . . , G. y1 is predefined or indicated, or y1 is equal to a difference between subcarrier sequence numbers of two adjacent reference signals, or y1 is equal to a difference between maximum subcarrier sequence numbers of two adjacent reference signals.

For example, if G=4, G_num=0, 1, 2, . . . , G−1, Δk=mod(G_num, y1), and y1=2, an offset of a start location of a reference signal sub-pattern used by a 0th subcarrier group is Δk=0, an offset of a start location of a reference signal sub-pattern used by a 1^{st} subcarrier group is Δk=1, an offset of a start location of a reference signal sub-pattern used by a 2^{nd} subcarrier group is Δk=0, and an offset of a start location of a reference signal sub-pattern used by a 3^{rd} subcarrier group is Δk=1.

For another example, the offset Δk of the start location of the reference signal in the (G_num)^{th} subcarrier group of the G subcarrier groups and G_num satisfy: Δk=G_num.

Determining manner 3: It may be agreed that an offset Δk of a start location of a reference signal in each subcarrier group of the G subcarrier groups is sequentially set within a preset range.

For example, an offset Δk of a start location of a reference signal in an i^{th} subcarrier group in the G subcarrier groups relative to a first subcarrier in the subcarrier group is an i^{th} value in a range of [0, y2]. For example, an offset of a start location of a reference signal in the G subcarrier groups is Δk=0, 1, 2, . . . , or y2. y2 is predefined or indicated, or y2 is equal to a difference between subcarrier sequence numbers of two adjacent reference signals, or y2 is equal to a difference between maximum subcarrier sequence numbers of two adjacent reference signals.

For another example, the offset Δk of the start location of the reference signal in the i^{th} subcarrier group in the G subcarrier groups relative to the first subcarrier in the subcarrier group is sequentially set, for example, Δk=0, 1, 2, . . . .

The first communication apparatus may determine, based on the quantity G of subcarrier groups and the offset between the reference signal sub-pattern used by each subcarrier group and the first reference signal sub-pattern, the reference signal pattern on the bandwidth used by the first communication apparatus. It should be understood that the reference signal pattern on the bandwidth used by the first communication apparatus is further related to the reference signal density.

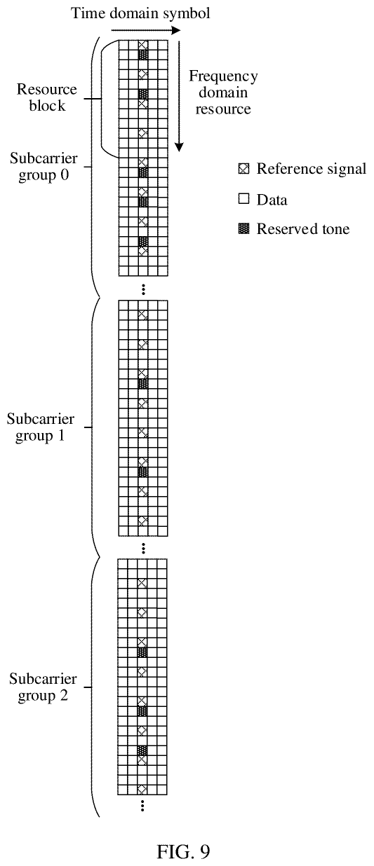

In an example, the subcarrier sequence number SC_index included in the reference signal pattern satisfies:
SC_index=(2n+k)/ρ+Δk, where ρ is the reference signal density in the bandwidth used by the first communication apparatus, n=0, 1, . . . , or N×ρ/2, N is the quantity of resource blocks or subcarriers included in the bandwidth used by the first communication apparatus, and k=0 or 1. For example, the bandwidth used by the first communication apparatus includes 132 RBs, and is divided into four subcarrier groups, that is, G=4. Subcarriers in each group are numbered from 0. For example, sequence numbers of subcarriers for 33 RBs in each group are 0 to 395. ρ=½ is used as an example, and Δk=[0, 1, 0, 1]. It can be learned from SC_index=(2n+k)/ρ+Δk that subcarrier numbers corresponding to reference signals in subcarrier group 0 are 0, 2, 4, 6, 8, 10, . . . , subcarrier numbers corresponding to reference signals in subcarrier group 1 are 1, 3, 5, 7, 9, . . . , subcarrier numbers corresponding to reference signals in subcarrier group 2 are 0, 2, 4, 6, 8, 10, . . . , and subcarrier numbers corresponding to reference signals in subcarrier group 3 are 1, 3, 5, 7, 9, . . . , as shown in FIG. 8. ρ=⅓, G=3 is used as an example, and Δk=[0, 1, 2]. It can be learned from SC_index=(2n+k)/ρ+Δk that subcarrier numbers corresponding to reference signals in subcarrier group 0 are 0, 3, 6, 9, . . . , subcarrier numbers corresponding to reference signals in subcarrier group 1 are 1, 4, 7, 10, . . . , and subcarrier numbers corresponding to reference signals in subcarrier group 2 are 2, 5, 8, 11 . . . , as shown in FIG. 9. FIG. 9 further shows a pattern of a reserved tone.

Optionally, it may be agreed that a subcarrier occupied by an offset reference signal is cyclically shifted in a corresponding subcarrier group, to avoid that a sequence number of the subcarrier occupied by the offset reference signal exceeds a subcarrier number range in the group. For example, a frequency domain resource on which a group of reference signals are located includes 33 RBs, and a subcarrier sequence number range of the frequency domain resource is 0 to 395. If a sequence number of the subcarrier on which the reference signal is located after offset exceeds 395, a modulo operation may be performed on the sequence number of the subcarrier obtained after offset, that is, being cyclically shifted within 0 to 395.

For example, a final sequence number RS_index_new of the subcarrier occupied by the reference signal satisfies:
RS_index_new=mod(RS_index_shifted, RE_num), where RS_index_shifted is the sequence number of the subcarrier initially determined by the first communication apparatus, and RE_num indicates a quantity of resources in the subcarrier group. For example, if RS_index_shifted is 397, and RE_num is 396, RS_index_new=mod(397, 396)=1, and the final sequence number of the subcarrier occupied by the reference signal is 1.

Optionally, SC_index=(2n+k)/ρ+x+Δk, where x is an original offset of a reference signal, that is, an offset between a sequence number of a 1^{st} subcarrier in a subcarrier group in which the first reference signal sub-pattern is located and a defined sequence number of the 1^{st} subcarrier. For example, it is defined that subcarrier symbols in a subcarrier group are numbered from 0. In this case, the sequence number of the 1^{st} subcarrier is 0. x=1 indicates that the sequence number of the 1^{st} subcarrier in the subcarrier group in which the first reference signal sub-pattern is located is 1. x=2 indicates that the sequence number of the 1^{st} subcarrier in the subcarrier group in which the first reference signal sub-pattern is located is 2.

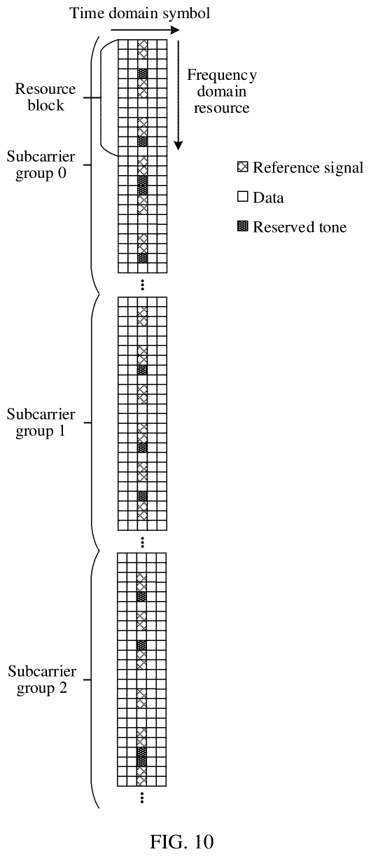

In another example, SC_index=(2n+k/2)/ρ+Δk is similar to the foregoing example. ρ=⅓, G=3 is used as an example, and Δk=[0, 1, 2]. It can be learned from SC_index=(2n+k)/ρ+Δk that subcarrier numbers corresponding to reference signals in subcarrier group 0 are 0, 1, 4, 5, . . . , subcarrier numbers corresponding to reference signals in subcarrier group 1 are 1, 2, 5, 6, . . . , and subcarrier numbers corresponding to reference signals in subcarrier group 2 are 2, 3, 6, 7 . . . , as shown in FIG. 10. FIG. 10 further shows a pattern of a reserved tone.

Optionally, SC_index=(2n+k/2)/ρ+x+Δk, where x is an original offset of a reference signal, that is, the offset between the sequence number of the 1^{st} subcarrier in the subcarrier group in which the first reference signal sub-pattern is located and the defined sequence number of the 1^{st} subcarrier.

In the foregoing example, the first communication apparatus determines the reference signal pattern in a manner of determining G and a sequence number of a subcarrier corresponding to each subcarrier group in the G subcarrier groups. In a possible implementation, the first communication apparatus or the second communication apparatus may alternatively determine, based on a to-be-used TR pattern, a to-be-used reference signal pattern. There are the following several determining manners.

Determining manner 4: Perform mapping on the TR pattern and the reference signal pattern. For example, Table 6 shows a correspondence between a TR pattern and a reference signal pattern. The first communication apparatus or the second communication apparatus determines, based on the to-be-used TR pattern, the to-be-used reference signal pattern.

For example, a mapping relationship between a TR pattern and a reference signal pattern may be predefined, preconfigured, or agreed on. The second communication apparatus configures, for the first communication apparatus, the to-be-used TR pattern as TR pattern 1, and the first communication apparatus and the second communication apparatus may determine, based on TR pattern 1 and Table 6, that the to-be-used reference signal pattern is reference signal pattern 1. For another example, the second communication apparatus configures, for the first communication apparatus, the to-be-used TR pattern as TR pattern 3, and the first communication apparatus and the second communication apparatus may determine, based on TR pattern 3 and Table 6, that the to-be-used reference signal pattern is reference signal pattern 3. If the to-be-used TR pattern indicated by the second communication apparatus to the first communication apparatus is not in the mapping relationship between a TR pattern and a reference signal pattern, that is, the to-be-used TR pattern has no mapped reference signal pattern. In this case, it may be agreed that the first communication apparatus and/or the second communication apparatus use/uses a default reference signal pattern, or use/uses a reference signal pattern configured in another manner (or a reference signal pattern configured in an existing manner, which may also be referred to as an original reference signal pattern). It should be noted that the mapping relationship shown in Table 6 is merely an example. The reference signal pattern in Table 6 may be any reference signal pattern shown in FIG. 8 to FIG. 10, and Table 6 may also be indicated by the second communication apparatus to the first communication apparatus.

TABLE 6

| TR pattern | Reference signal pattern |
|---|---|
| TR pattern 1 | Reference signal pattern 1 |
| TR pattern 2 | Reference signal pattern 2 |
| TR pattern 3 | Reference signal pattern 3 |
| TR pattern 4 | Reference signal pattern 4 |
| TR pattern 5 | Reference signal pattern 5 |
| . . . | . . . |

For still another example, a mapping relationship among a quantity of frequency domain resources, a TR pattern, and a reference signal pattern may be predefined, preconfigured, or agreed on. The first communication apparatus and/or the second communication apparatus determine/determines the to-be-used reference signal pattern based on the quantity of frequency domain resources and the to-be-used TR pattern. For example, Table 7 shows a mapping relationship among a quantity of frequency domain resources, a TR pattern, and a reference signal pattern. Based on Table 7, the second communication apparatus configures 66 RBs for the first communication apparatus, and the second communication apparatus configures the to-be-used TR pattern for the first communication apparatus as TR pattern 1. The first communication apparatus and the second communication apparatus may determine to use reference signal pattern 1 to send or receive a signal. It should be noted that the mapping relationship shown in Table 7 is merely an example. The reference signal pattern in Table 7 may be any reference signal pattern shown in FIG. 8 to FIG. 10, and Table 7 may also be indicated by the second communication apparatus to the first communication apparatus.

TABLE 7

| Quantity of RBs | TR pattern | Reference signal pattern |
|---|---|---|
| 66 | TR pattern 1 | Reference signal pattern 1 |
| 66 | TR pattern 2 | Reference signal pattern 2 |
| 66 | TR pattern 3 | Reference signal pattern 3 |
| 132 | TR pattern 4 | Reference signal pattern 4 |
| 132 | TR pattern 5 | Reference signal pattern 5 |
| . . . | . . . | . . . |

For another example, a mapping relationship between a TR pattern and a reference signal pattern may be predefined, agreed on, or preconfigured, and an index is established for the TR pattern and the reference signal pattern. For example, Table 8 shows a mapping relationship among an index, a TR pattern, and a reference signal pattern. The second communication apparatus configures the TR pattern and the reference signal pattern by sending an index number to the first communication apparatus. For example, when the second communication apparatus configures an index number of 1 for the first communication apparatus, the first communication apparatus and/or the second communication apparatus may determine, based on Table 8, to send or receive a signal by using TR pattern 2 and reference signal pattern 2. It should be noted that the mapping relationship shown in Table 8 is merely an example. The reference signal pattern in Table 8 may be any reference signal pattern shown in FIG. 8 to FIG. 10, and Table 8 may also be indicated by the second communication apparatus to the first communication apparatus.

TABLE 8

| Index number | TR pattern | Reference signal pattern |
|---|---|---|
| 0 | TR pattern 1 | Reference signal pattern 1 |
| 1 | TR pattern 2 | Reference signal pattern 2 |
| 2 | TR pattern 3 | Reference signal pattern 3 |
| 3 | TR pattern 4 | Reference signal pattern 4 |
| 4 | TR pattern 5 | Reference signal pattern 5 |
| . . . | . . . | . . . |

Optionally, the second communication apparatus may configure a TR pattern and a corresponding reference signal pattern for the first communication apparatus. The reference signal pattern is, for example, any reference signal pattern shown in FIG. 8 to FIG. 10. In a possible implementation, the second communication apparatus may configure the TR pattern for the first communication apparatus by using an index. For example, Table 9 shows a mapping relationship between an index and a TR pattern. When an index number of a TR pattern configured by the second communication apparatus for the first communication apparatus is 1, the first communication apparatus and/or the second communication apparatus may determine, based on Table 9, to use TR pattern 2. For example, Table 10 shows a mapping relationship between an index and a reference signal pattern. When an index number of a reference signal pattern configured by the second communication apparatus for the first communication apparatus is 1, the first communication apparatus and/or the second communication apparatus may determine, based on Table 10, to use reference signal pattern 2. Because the TR pattern and the reference signal pattern may be indicated by using different indexes, different combinations of the TR pattern and the reference signal pattern may be flexibly indicated, to optimize system spectral efficiency. It should be noted that the mapping relationships shown in Table 9 and Table 10 are merely examples. The reference signal pattern in Table 10 may be any reference signal pattern shown in FIG. 8 to FIG. 10. Table 9 and/or Table 10 may be predefined or agreed on, or may be indicated by the second communication apparatus to the first communication apparatus.

TABLE 9

| TR pattern index number | TR pattern |
|---|---|
| 0 | TR pattern 1 |
| 1 | TR pattern 2 |
| 2 | TR pattern 3 |
| 3 | TR pattern 4 |
| 4 | TR pattern 5 |
| . . . | . . . |

TABLE 10

| Reference signal pattern | |
|---|---|
| index number | Reference signal pattern |
| 0 | Reference signal pattern 1 |
| 1 | Reference signal pattern 2 |
| 2 | Reference signal pattern 3 |
| 3 | Reference signal pattern 4 |
| 4 | Reference signal pattern 5 |
| . . . | . . . |

Determining manner 5: A mapping relationship among a TR pattern, a reference signal density and/or an original reference signal pattern, and a reference signal pattern may be predefined, agreed on, or preconfigured. That is, mapping is performed on the TR pattern, the reference signal density and/or the original reference signal pattern, and the reference signal pattern. The original reference signal pattern is a reference signal pattern configured by using the conventional technology, or a reference signal pattern configured by using the conventional technology when TR pattern adaptation is not considered, or a reference signal pattern configured for another communication function (for example, to resist impact of phase noise) in a system.

For example, Table 11 shows a mapping relationship among a TR pattern, a reference signal density and/or an original reference signal pattern, and a reference signal pattern. The first communication apparatus and/or the second communication apparatus may determine the to-be-used reference signal pattern based on the TR pattern and the reference signal density and/or the original reference signal pattern that are to be used, and the mapping relationship. It should be noted that the mapping relationship shown in Table 11 is merely an example. The reference signal pattern in Table 11 may be any reference signal pattern shown in FIG. 8 to FIG. 10, and Table 11 may also be indicated by the second communication apparatus to the first communication apparatus.

TABLE 11

| | Reference signal density | |
|---|---|---|
| | (and/or original reference | Reference signal |
| TR pattern | signal pattern) | pattern |
| TR pattern 1 | 1/2 (and/or original reference | Reference signal |
| | signal pattern 1) | pattern 1 |
| TR pattern 2 | 1/3 (and/or original reference | Reference signal |
| | signal pattern 2) | pattern 2 |
| TR pattern 3 | 1/4 (and/or original reference | Reference signal |
| | signal pattern 3) | pattern 3 |
| TR pattern 4 | 1/2 (and/or original reference | Reference signal |
| | signal pattern 4) | pattern 4 |
| TR pattern 5 | 1/3 (and/or original reference | Reference signal |
| | signal pattern 5) | pattern 5 |
| . . . | . . . | . . . |

As shown in Table 11, when the first communication apparatus and/or the second communication apparatus use/uses TR pattern 1 and the reference signal density of ½ (and/or original reference signal pattern 1), based on Table 11, the first communication apparatus and/or the second communication apparatus determine/determines to use TR pattern 1 and reference signal pattern 1 to send or receive a signal; and when the first communication apparatus and/or the second communication apparatus use/uses TR pattern 3 and the reference signal density of ¼ (and/or original reference signal pattern 3), based on Table 11, the first communication apparatus and/or the second communication apparatus determine/determines to use TR pattern 3 and reference signal pattern 3 to send or receive a signal. If the to-be-used TR pattern indicated by the second communication apparatus to the first communication apparatus is not included in Table 11, that is, the to-be-used TR pattern has no mapped reference signal pattern, it may be agreed that the first communication apparatus and/or the second communication apparatus use/uses a default reference signal pattern, or use/uses a reference signal pattern configured in another manner (for example, the original reference signal pattern).

Optionally, a mapping relationship among a quantity of frequency domain resources, a TR pattern, a reference signal density and/or an original reference signal pattern, and a reference signal pattern may be predefined, agreed on, or preconfigured. That is, mapping is performed on the quantity of frequency domain resources, the TR pattern, the reference signal density and/or the original reference signal pattern, and the reference signal pattern. The reference signal pattern may be any reference signal pattern shown in FIG. 8 to FIG. 10. For example, Table 12 shows a mapping relationship among a quantity of RBs, a TR pattern, a reference signal density and/or an original reference signal pattern, and a reference signal pattern. The first communication apparatus and/or the second communication apparatus may determine the to-be-used reference signal pattern based on the quantity of RBs, the TR pattern, and the reference signal density and/or the original reference signal pattern that are to be used, and the mapping relationship. It should be noted that the mapping relationship shown in Table 12 is merely an example, and Table 12 may also be indicated by the second communication apparatus to the first communication apparatus.

TABLE 12

| | | Reference signal density | |
|---|---|---|---|
| Quantity | | (and/or original reference | Reference signal |
| of RBs | TR pattern | signal pattern) | pattern |
| 66 | TR pattern 1 | 1/2 (and/or original reference | Reference signal |
| | | signal pattern 1) | pattern 1 |
| 66 | TR pattern 2 | 1/3 (and/or original reference | Reference signal |
| | | signal pattern 2) | pattern 2 |
| 66 | TR pattern 3 | 1/4 (and/or original reference | Reference signal |
| | | signal pattern 3) | pattern 3 |
| 132 | TR pattern 4 | 1/2 (and/or original reference | Reference signal |
| | | signal pattern 4) | pattern 4 |
| 132 | TR pattern 5 | 1/3 (and/or original reference | Reference signal |
| | | signal pattern 5) | pattern 5 |
| . . . | . . . | . . . | . . . |

As shown in Table 12, when the quantity of RBs of the first communication apparatus and/or the second communication apparatus is 66, the to-be-used TR pattern is TR pattern 1, and the reference signal density is ½ (and/or original reference signal pattern 1), based on Table 12, the first communication apparatus and/or the second communication apparatus determine/determines to use reference signal pattern 1 to send or receive a signal; and when the quantity of RBs of the first communication apparatus and/or the second communication apparatus is 66, the to-be-used TR pattern is TR pattern 3, and the reference signal density is ¼ (and/or original reference signal pattern 3), based on Table 12, the first communication apparatus and/or the second communication apparatus determine/determines to use reference signal pattern 3 to send or receive a signal. If the quantity of frequency domain resources and/or the TR pattern that are/is to be used and that are indicated by the second communication apparatus to the first communication apparatus are/is not included in Table 12, that is, the quantity of domain resources and/or the TR pattern that are/is to be used have/has no mapped reference signal pattern, it may be agreed that the first communication apparatus and/or the second communication apparatus use/uses a default reference signal pattern, or use/uses a reference signal pattern configured in another manner (for example, the original reference signal pattern).

Determining manner 6: The first communication apparatus/the second communication apparatus determines, based on the to-be-used TR pattern, a quantity G of to-be-used subcarrier groups and/or offset information, that is, mapping is performed on the TR pattern, the quantity G of subcarrier groups, and/or the offset information. After obtaining the quantity G of subcarrier groups and/or the offset information, the first communication apparatus/the second communication apparatus may determine, according to, for example, any one of Determining manner 1 to Determining manner 3 in the foregoing embodiment, a reference signal pattern that adapts to a to-be-used reserved tone.

For example, a mapping relationship among a TR pattern, a quantity G of subcarrier groups, and/or offset information may be predefined, preconfigured, or agreed on, as shown in Table 13. It should be noted that the mapping relationship shown in Table 13 is merely an example, and Table 13 may also be indicated by the second communication apparatus to the first communication apparatus.

TABLE 13

| | Quantity | Offset Δk between a reference signal |
|---|---|---|
| | G of | sub-pattern used by each subcarrier |
| | subcarrier | group and a first reference |
| TR pattern | groups | signal sub-pattern |
| TR pattern 1 | 4 | 0, 1, 0, 1 |
| TR pattern 2 | 6 | 0, 1, 2, 0, 1, 2 |
| TR pattern 3 | 8 | 0, 1, 0, 1, 0, 1, 0, 1 |
| TR pattern 4 | 16 | 0, 1, 2, 3, 0, 1, 2, 3, 0, 1, 2, 3, 0, 1, 2, 3 |
| TR pattern 5 | 24 | 0, 1, 2, 3, 0, 1, 2, 3, 0, 1, 2, 3, |
| | | 0, 1, 2, 3, 0, 1, 2, 3, 0, 1, 2, 3, |
| . . . | . . . | . . . |

The second communication apparatus configures a to-be-used TR pattern for the first communication apparatus. The first communication apparatus and the second communication apparatus determine, based on the TR pattern and the mapping relationship shown in Table 13, the quantity G of to-be-used subcarrier groups and/or the offset information, and then determine the reference signal pattern based on the quantity G of subcarrier groups and/or the offset information. When the TR pattern used by the first communication apparatus and/or the second communication apparatus is TR pattern 1, based on Table 13, the first communication apparatus and/or the second communication apparatus may determine that the quantity of subcarrier groups is G=4, and the offset information is {0,1,0,1}, and send or receive a signal after determining the reference signal pattern. When the TR pattern used by the first communication apparatus and/or the second communication apparatus is TR pattern 3, based on Table 13, the first communication apparatus and/or the second communication apparatus determine/determines that the quantity of subcarrier groups is G=8, and the offset information is {0,1,0,1,0,1,0,1}, and send/sends or receive/receives a signal after determining the reference signal pattern. If the to-be-used TR pattern that is configured by the second communication apparatus for the first communication apparatus is not in the mapping relationship shown in Table 13, that is, the to-be-used TR pattern has no mapped quantity G of subcarrier groups and/or offset information, it may be agreed that the first communication apparatus and/or the second communication apparatus use/uses a default reference signal pattern, or use/uses a reference signal pattern configured in another manner (for example, the original reference signal pattern).

Optionally, mapping is performed on the quantity of frequency domain resources, the TR pattern, the quantity G of subcarrier groups, and/or the offset information. For example, a mapping relationship among a quantity of RBs, a TR pattern, a quantity G of subcarrier groups, and/or offset information may be predefined, preconfigured, or agreed on, as shown in Table 14. It should be noted that the mapping relationship shown in Table 14 is merely an example, and Table 14 may also be indicated by the second communication apparatus to the first communication apparatus.

TABLE 14

| | | | Offset Δk between a |
|---|---|---|---|
| | | Quantity | reference signal sub-pattern |
| | | G of | used by each subcarrier |
| Quantity | | subcarrier | group and a first reference |
| of RBs | TR pattern | groups | signal sub-pattern |
| 66 | TR pattern 1 | 4 | 0, 1, 0, 1 |
| 66 | TR pattern 2 | 6 | 0, 1, 2, 0, 1, 2 |
| 66 | TR pattern 3 | 8 | 0, 1, 0, 1, 0, 1, 0, 1 |
| 132 | TR pattern 4 | 16 | 0, 1, 2, 3, 0, 1, 2, 3, 0, 1, 2, 3, |
| | | | 0, 1, 2, 3 |
| 132 | TR pattern 5 | 24 | 0, 1, 2, 3, 0, 1, 2, 3, 0, 1, 2, 3, |
| | | | 0, 1, 2, 3, 0, 1, 2, 3, 0, 1, 2, 3, |
| . . . | . . . | . . . | . . . |

As shown in Table 14, when the quantity of RBs of the first communication apparatus and/or the second communication apparatus is 66, and the to-be-used TR pattern is TR pattern 1, based on Table 14, the first communication apparatus and/or the second communication apparatus may determine that the quantity of subcarrier groups is G=4, and the offset information is {0,1,0,1}, and send or receive a signal after determining the reference signal pattern; and when the quantity of RBs of the first communication apparatus and/or the second communication apparatus is 66, and the to-be-used TR pattern is TR pattern 3, based on Table 14, the first communication apparatus and/or the second communication apparatus may determine that the quantity of to-be-used subcarrier groups is G=8, and the offset information is {0,1,0,1,0,1,0,1}, and send or receive a signal after determining the reference signal pattern. If the quantity of frequency domain resources and/or the TR pattern that are/is to be used and that are configured by the second communication apparatus for the first communication apparatus are/is not in the mapping relationship shown in Table 14, that is, the quantity of domain resources and/or the TR pattern that are/is to be used have/has no mapped quantity G of subcarrier groups and/or offset information, it may be agreed that the first communication apparatus and/or the second communication apparatus use/uses a default reference signal pattern, or use/uses a reference signal pattern configured in another manner (for example, the original reference signal pattern).

Determining manner 7: Perform mapping on the TR pattern, the reference signal density and/or the original reference signal pattern, and the quantity G of subcarrier groups and/or the offset information. For example, a mapping relationship among a TR pattern, a reference signal density and/or an original reference signal pattern, and a quantity G of subcarrier groups and/or offset information may be predefined, preconfigured, or agreed on, as shown in Table 15. It should be noted that the mapping relationship shown in Table 15 is merely an example, and Table 15 may also be indicated by the second communication apparatus to the first communication apparatus.

TABLE 15

| | | | Offset Δk between a |
|---|---|---|---|
| | Reference signal | Quantity | reference signal sub-pattern |
| | density (and/or | G of | used by each subcarrier |
| TR | original reference | subcarrier | group and a first reference |
| pattern | signal pattern) | groups | signal sub-pattern |
| TR | 1/2 (and/or original | 4 | 0, 1, 0, 1 |
| pattern 1 | reference signal | | |
| | pattern 1) | | |
| TR | 1/3 (and/or original | 6 | 0, 1, 2, 0, 1, 2 |
| pattern 2 | reference signal | | |
| | pattern 2) | | |
| TR | 1/4 (and/or original | 8 | 0, 1, 0, 1, 0, 1, 0, 1 |
| pattern 3 | reference signal | | |
| | pattern 3) | | |
| TR | 1/2 (and/or original | 16 | 0, 1, 2, 3, 0, 1, 2, 3, |
| pattern 4 | reference signal | | 0, 1, 2, 3, 0, 1, 2, 3 |
| | pattern 4) | | |
| TR | 1/3 (and/or original | 24 | 0, 1, 2, 3, 0, 1, 2, 3, 0, 1, 2, 3, |
| pattern 5 | reference signal | | 0, 1, 2, 3, 0, 1, 2, 3, 0, 1, 2, 3, |
| | pattern 5) | | |
| . . . | . . . | . . . | . . . |

Based on Table 15, the first communication apparatus/the second communication apparatus may determine, based on the TR pattern and the reference signal density and/or the original reference signal pattern that are to be used, the quantity G of to-be-used subcarrier groups and/or the offset information, and then determine, based on the quantity G of subcarrier groups and/or the offset information, the reference signal pattern that adapts to the to-be-used reserved tone. For example, based on Table 15, when the first communication apparatus and/or the second communication apparatus determine/determines to use TR pattern 1 and the reference signal density of ½ and/or original reference signal pattern 1, the first communication apparatus and/or the second communication apparatus may determine that the quantity of subcarrier groups is G=4, and the offset information is {0,1,0,1}, and then determine, based on the quantity of subcarrier groups G=4 and the offset information {0,1,0,1}, the reference signal pattern that adapts to the to-be-used reserved tone; and when the first communication apparatus and/or the second communication apparatus determine/determines to use TR pattern 3 and the reference signal density of ¼ and/or original reference signal pattern 3, the first communication apparatus and/or the second communication apparatus may determine that the quantity of subcarrier groups is G=8, and the offset information is {0,1,0,1,0,1,0,1}, and then determine, based on the quantity of subcarrier groups G=8 and the offset information {0,1,0,1,0,1,0,1}, the reference signal pattern that adapts to the to-be-used reserved tone. If the reference signal density (and/or the original reference signal pattern) and/or the TR pattern that are/is to be used and that are/is configured by the second communication apparatus for the first communication apparatus are/is not in the mapping relationship shown in Table 15, that is, the reference signal density (and/or the original reference signal pattern) and/or the TR pattern that are/is to be used have/has no mapped quantity G of subcarrier groups and/or offset information, it may be agreed that the first communication apparatus and/or the second communication apparatus use/uses a default reference signal pattern, alternatively, or use/uses a reference signal pattern configured in another manner (for example, the original reference signal pattern).

Optionally, the quantity of frequency domain resources, the TR pattern, the reference signal density and/or the original reference signal pattern, the quantity G of subcarrier groups, and/or the offset information may be predefined, agreed on, or preconfigured, as shown in Table 16. It should be noted that the mapping relationship shown in Table 16 is merely an example, and Table 16 may also be indicated by the second communication apparatus to the first communication apparatus.

TABLE 16

| | | | | Offset Δk between |
|---|---|---|---|---|
| | | | | a reference signal |
| | | Reference signal | Quantity | sub-pattern used by |
| | | density (and/or | G of | each subcarrier group |
| Quantity | TR | original reference | subcarrier | and a first reference |
| of RBs | pattern | signal pattern) | groups | signal sub-pattern |
| 66 | TR | 1/2 (and/or original | 4 | 0, 1, 0, 1 |
| | pattern 1 | reference signal | | |
| | | pattern 1) | | |
| 66 | TR | 1/3 (and/or original | 6 | 0, 1, 2, 0, 1, 2 |
| | pattern 2 | reference signal | | |
| | | pattern 2) | | |
| 66 | TR | 1/4 (and/or original | 8 | 0, 1, 0, 1, 0, 1, 0, 1 |
| | pattern 3 | reference signal | | |
| | | pattern 3) | | |
| 132 | TR | 1/2 (and/or original | 16 | 0, 1, 2, 3, 0, 1, 2, 3, |
| | pattern 4 | reference signal | | 0, 1, 2, 3, 0, 1, 2, 3 |
| | | pattern 4) | | |
| 132 | TR | 1/3 (and/or original | 24 | 0, 1, 2, 3, 0, 1, 2, 3, |
| | pattern 5 | reference signal | | 0, 1, 2, 3, 0, 1, 2, 3, |
| | | pattern 5) | | 0, 1, 2, 3, 0, 1, 2, 3, |
| . . . | . . . | . . . | . . . | . . . |

Based on Table 16, the first communication apparatus and the second communication apparatus may determine the quantity G of subcarrier groups and/or the offset information based on the quantity of frequency domain resources, the TR pattern, the reference signal density (and/or the original reference signal pattern), and Table 16. For example, when the quantity of RBs of the first communication apparatus and/or the second communication apparatus is 66, TR pattern 1 is used, and the reference signal density is ½ (and/or original reference signal pattern 1), based on Table 16, the first communication apparatus and/or the second communication apparatus determine/determines that the quantity of subcarrier groups is G=4, and the offset information is {0,1,0,1}, and then may determine the reference signal pattern that adapts to the to-be-used reserved tone; and when the quantity of RBs of the first communication apparatus and/or the second communication apparatus is 66, TR pattern 3 is used, and the reference signal density is ¼ (and/or original reference signal pattern 3), based on Table 16, the first communication apparatus and/or the second communication apparatus determine/determines that the quantity of subcarrier groups is G=8, and the offset information is {0,1,0,1,0,1,0,1}, and then determine/determines the reference signal pattern that adapts to the to-be-used reserved tone. If the quantity of frequency domain resources and/or the TR pattern and/or the reference signal density (the original reference signal pattern) that are/is to be used and that are/is configured by the second communication apparatus for the first communication apparatus are/is not in the mapping relationship shown in Table 16, that is, the quantity of domain resources and/or the TR pattern that are/is to be used have/has no mapped quantity G of subcarrier groups and/or offset information, it may be agreed that the first communication apparatus and/or the second communication apparatus use/uses a default reference signal pattern, or use/uses a reference signal pattern configured in another manner (for example, the original reference signal pattern).

The foregoing embodiments may be used in combination with each other to obtain different implementations. For example, Table 8 and Table 12 are combined for an implementation in which the quantity of RBs, the TR pattern, the reference signal density, and the reference signal pattern are indicated by using an index number. For another example, Table 8 and the foregoing mapping relationship may be configured for the first communication apparatus for combination. To be specific, the second communication apparatus configures Table 8 for the first communication apparatus, and then the second communication apparatus indicates, by sending an index number, the TR pattern and the reference signal pattern that are to be used to the first communication apparatus. Other combination manners are not listed herein one by one. In addition, the value in the mapping relationship in the foregoing embodiment is merely used as an example, and does not limit a specific value. The mapping relationship, the index relationship, and the like in the foregoing embodiment may be obtained by the first communication apparatus and the second communication apparatus in a manner of protocol agreement, pre-configuration, or agreement, so that signaling overheads can be reduced, or obtained through sending the relationship by the second communication apparatus to the first communication apparatus, to facilitate flexible configuration and real-time change of the mapping relationship.

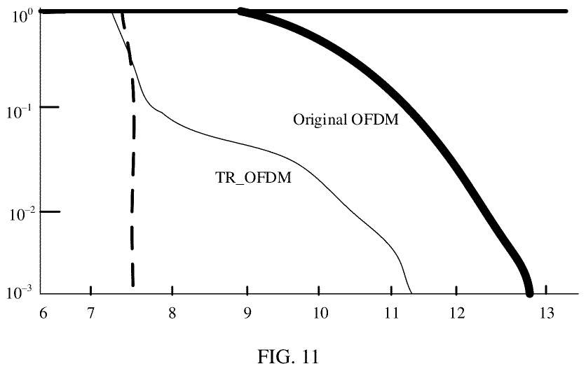

As shown in FIG. 8 to FIG. 10, in this embodiment of this application, the bandwidth used by the first communication apparatus uses at least two reference signal sub-patterns. It may be considered that reference signals on the bandwidth used by the first communication apparatus are unevenly distributed. This can avoid an excessively large secondary peak value of a kernel time domain signal generated on a subcarrier used as a reserved tone, thereby improving the PAPR suppression performance. However, a reference signal in each subcarrier group is evenly distributed, to ensure decoding performance of a receive end. For example, FIG. 11 is a diagram of PAPR suppression performance in a same reference signal density based on a TR technology separately in cases of an even reference signal pattern and an uneven reference signal pattern. In FIG. 11, a thick line represents PAPR suppression performance obtained when a reserved tone is not used, a thin line represents PAPR suppression performance obtained when a reserved tone is used in the even reference signal pattern, and a dashed line represents PAPR suppression performance obtained when a reserved tone is used in the uneven reference signal pattern. It can be learned from FIG. 11 that the PAPR suppression performance that can be achieved by using the TR technology in the uneven reference signal pattern is higher than the PAPR suppression performance that can be achieved by using the TR technology in the even reference signal pattern, and performance is improved by about 3 dB.

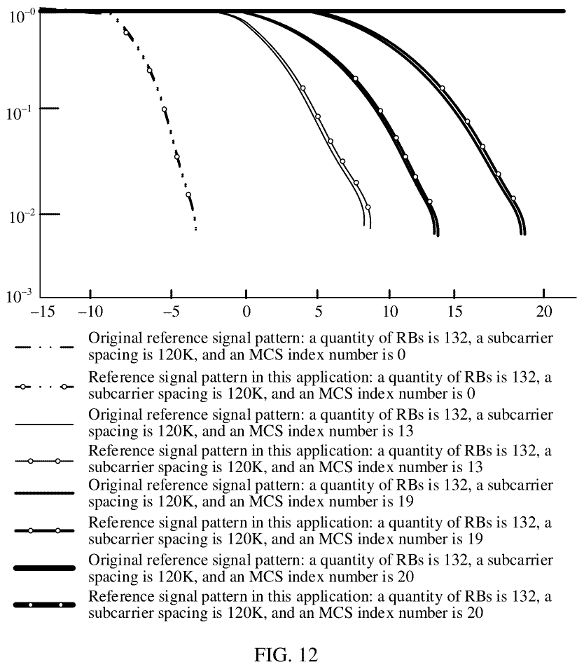

In addition, a reference signal in each subcarrier group is evenly distributed, so that the decoding performance of the receive end can be ensured. For example, FIG. 12 is a diagram of decoding performance in a same reference signal density based on a TR technology separately in cases of an even reference signal pattern (that is, the reference signal pattern provided in this application) and an uneven reference signal pattern (that is, the reference signal pattern provided in this application). In FIG. 12, an example in which indexes of a modulation and coding scheme (modulation and coding scheme, MCS) are 0, 13, 19, and 20, a quantity of RBs is 132, and a subcarrier spacing is 120 KHz is used. It can be learned from FIG. 12 that in cases of the uneven reference signal pattern and the even reference signal pattern, when the TR technology is used to suppress the PAPR, which has little impact on the decoding performance of the receive end. In other words, the reference signal pattern provided in this embodiment of this application can not only improve the PAPR suppression performance, but also ensure the decoding performance of the receive end. Optionally, if the receive end allows a small decoding performance loss, reference signals in a subcarrier group may also be unevenly distributed.

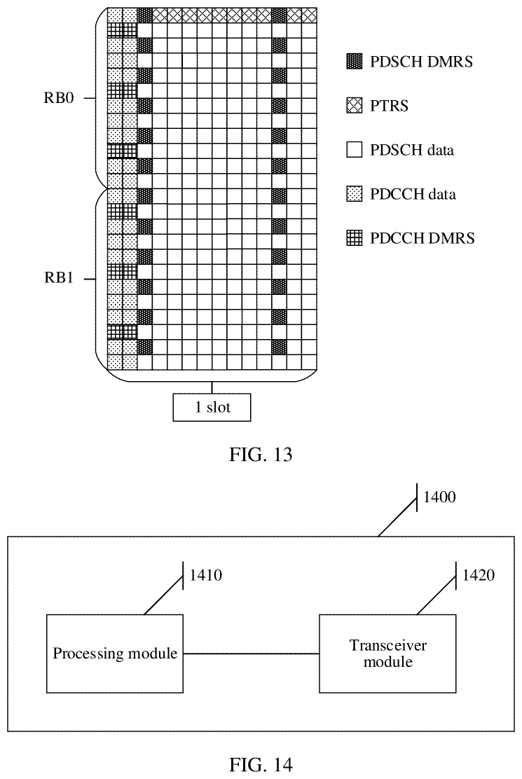

Alternatively, the second reference signal sub-pattern may be an offset of the first reference signal sub-pattern in time domain. Whether reference signal patterns and reference signal densities used between different symbols are the same is not limited in this embodiment of this application. For example, reference signal patterns and/or reference signal densities used between different symbols may be the same, or may be different. For example, FIG. 13 shows a reference signal pattern in a slot. In FIG. 13, an example in which one slot includes 14 symbols, that is, symbol 0 to symbol 13 is used. As shown in FIG. 13, a DMRS density between symbol 0 and symbol 1 is ¼, a reference signal density between symbol 2 and symbol 11 is ½, and a PTRS density among remaining symbols: symbol 3 to symbol 10, symbol 12, and symbol 13 is 1/24. Reference signal densities between different symbols may be different, and corresponding TR patterns may also be different.

S603: The first communication apparatus performs data transmission based on the reference signal pattern and the TR pattern.

When performing data transmission, the first communication apparatus may select a reference signal pattern and a TR pattern that are to be used. For example, when the first communication apparatus determines not to use the reserved tone, the first communication apparatus determines that the reference signal pattern includes only the first reference signal sub-pattern. When the reference signal pattern includes only the first reference signal sub-pattern, the first communication apparatus may use a current reference signal pattern. When the first communication apparatus determines to use the reserved tone, the first communication apparatus determines that the reference signal pattern includes the first reference signal sub-pattern and the second reference signal sub-pattern. When the reference signal pattern includes the first reference signal sub-pattern and the second reference signal sub-pattern, the first communication apparatus may determine a to-be-used TR pattern based on the reference signal density and/or the quantity of frequency domain resources. Alternatively, a subcarrier used as a reserved tone is selected from subcarriers other than a subcarrier occupied by a reference signal. In time domain, each symbol may adaptively determine a to-be-used reference signal pattern based on one or more of the following information: whether a reserved tone is used, a corresponding original reference signal pattern, a reference signal density, and a quantity of frequency domain resources, or determine a quantity G of subcarrier groups and offset information of a reference signal sub-pattern corresponding to each subcarrier group, to determine a reference signal pattern and/or a TR pattern. For example, Table 17 shows a correspondence among a quantity of RBs, a reference signal density, and a TR pattern. When the first communication apparatus suppresses the PAPR by using the TR technology, a proper TR pattern may be selected based on Table 17, that is, high PAPR suppression performance and good spectral efficiency are achieved as much as possible.

TABLE 17

| Quantity | Reference signal | |
|---|---|---|
| of RBs | density | TR pattern |
| 66 | 0 | TR pattern 1 |
| 66 | 1/2 | TR pattern 2 |
| 66 | 1/4 | TR pattern 3 |
| 66 | 1/24 | TR pattern 4 |
| 132 | 0 | TR pattern 5 |
| 132 | 1/2 | TR pattern 6 |
| 132 | 1/4 | TR pattern 7 |
| 132 | 1/24 | TR pattern 8 |

In this embodiment of this application, information sent by the network device to the terminal device, for example, G, offset information, a first mapping relationship, a second mapping relationship, and a third mapping relationship, may be carried in a system message, for example, at least one of the following types of broadcast information: system information block (SIB) 1, other system information (OSI), a master information block (MIB), and the like. Optionally, the network device may send G, the offset information, the first mapping relationship, the second mapping relationship, or the third mapping relationship to the terminal device through broadcast or multicast, to avoid that different resources need to be scheduled for different devices, thereby reducing signaling overheads for resource scheduling and reducing system scheduling complexity.

If information sent by the network device to the terminal device is sent in an RRC connection establishment phase and a subsequent communication process, the network device may send the information to the first communication apparatus by using at least one of the following: RRC signaling (for example, an RRC setup (RRCsetup) message, RRC reconfiguration signaling (RRCReconfiguration), or RRC resume signaling (RRCResume)), downlink control information (DCI), group DCI, or a media access control (MAC) control element (CE). Alternatively, the information sent by the network device to the terminal device may be transmitted to the terminal device along with data. Alternatively, the information sent by the network device to the terminal device may be carried on a physical downlink shared channel (PDSCH) separately allocated to the terminal device. In this way, for different terminal devices, corresponding information, for example, G and offset information, may be sent, to flexibly control a parameter value of each terminal device. Further, different parameters such as G and offset information may be sent to the terminal device based on different link budgets of locations, regions, or the like of the terminal device, that is, different reference signal patterns may be configured, to optimize system transmit power efficiency and optimize terminal device communication performance/system communication performance. For example, based on different geographical locations, different required link budgets, and different transmit signal power requirements of the terminal device, different G, offset information, and TR reserved tones may be configured and used, to optimize PAPR suppression performance of each/each group of terminal devices, avoid wasting spectrum resources and transmit efficiency, and improve overall communication performance of the terminal devices and the system.

In embodiments provided in this application, the method provided in embodiments of this application is separately described from perspectives of a first communication apparatus, a second communication apparatus, and interaction between the first communication apparatus and the second communication apparatus. To implement the functions in the methods provided in embodiments of this application, the first communication apparatus and the second communication apparatus each may include a hardware structure and/or a software module. The foregoing functions are implemented in a form of a hardware structure, a software module, or a combination of a hardware structure and a software module. Whether a function in the foregoing functions is performed by using the hardware structure, the software module, or the combination of the hardware structure and the software module depends on particular applications and implementation constraints of the technical solutions.

The following describes, with reference to the accompanying drawings, communication apparatuses, in embodiments of this application, configured to implement the foregoing methods.

FIG. 14 is a schematic block diagram of a communication apparatus 1400 according to an embodiment of this application. The communication apparatus 1400 may include a processing module 1410 and a transceiver module 1420. Optionally, a storage unit may be included. The storage unit may be configured to store instructions (code or a program) and/or data. The processing module 1410 and the transceiver module 1420 may be coupled to the storage unit. For example, the processing module 1410 may read the instructions (the code or the program) and/or the data in the storage unit, to implement a corresponding method. The foregoing modules may be disposed independently, or may be partially or completely integrated.

In some possible implementations, the communication apparatus 1400 can correspondingly implement behavior and functions of the communication apparatus in the foregoing method embodiments. The communication apparatus 1400 may be a communication apparatus, or may be a component (for example, a chip or a circuit) used in the communication apparatus, or may be a chip or a chip group in the communication apparatus, or a part of a chip that is configured to perform a related method function.

For example, the communication apparatus 1400 implements the method performed by the communication apparatus in embodiments of this application. The processing module 1410 may be configured to determine to: use a reserved tone, and determine a reference signal pattern and a tone reservation TR pattern. The reference signal pattern includes a first reference signal sub-pattern and a second reference signal sub-pattern, and the second reference signal sub-pattern is an offset of the first reference signal sub-pattern in time domain and/or frequency domain. The transceiver module 1420 is configured to perform data transmission based on the reference signal pattern and the TR pattern.

In an optional implementation, the processing module 1410 is further configured to determine not to use a reserved tone, where the reference signal pattern includes only the first reference signal sub-pattern.

In an optional implementation, the bandwidth used by the communication apparatus 1400 includes G subcarrier groups, at least one subcarrier group in the G subcarrier groups uses the first reference signal sub-pattern, and at least one subcarrier group in the G subcarrier groups uses the second reference signal sub-pattern, where G is an integer greater than or equal to 2.

In an optional implementation, the processing module 1410 is further configured to determine G based on a first density, where the first density is a reference signal density in the bandwidth used by the communication apparatus 1400. The processing module 1410 is specifically configured to determine G based on the first density and a first mapping relationship, where the first mapping relationship is a relationship between a quantity of subcarrier groups and a reference signal density; the processing module 1410 is specifically configured to determine G based on the first density, a first quantity of resources, and a second mapping relationship, where the second mapping relationship is a relationship among a quantity of subcarrier groups, a reference signal density, and a quantity of resources, and the first quantity of resources is a quantity of resource blocks or subcarriers included in the bandwidth used by the communication apparatus; the processing module 1410 is specifically configured to determine G based on a first coefficient and the first density, where G is a product of the first coefficient and the first density, and the first coefficient is predefined, preconfigured, or indicated; or G is predefined, agreed on, or preconfigured.

In an optional implementation, the communication apparatus 1400 is a terminal device, and the transceiver module 1420 is further configured to receive G; or the transceiver module 1420 is further configured to receive a second quantity of resources, and the processing module 1410 is further configured to determine G based on the second quantity of resources, where the second quantity of resources is a quantity of resource blocks or subcarriers included in one subcarrier group.

In an optional implementation, the communication apparatus 1400 is a network device, and the transceiver module 1420 is further configured to send G, or the transceiver module 1420 is further configured to send a second quantity of resources, where the second quantity of resources is used to determine G.

In an optional implementation, the processing module 1410 is further configured to determine offset information, where the offset information indicates an offset between the second reference signal sub-pattern and the first reference signal sub-pattern in time domain and/or frequency domain.

In an optional implementation, the processing module 1410 is specifically configured to determine the offset information based on group numbers of the G subcarrier groups, where an offset Δk of a start location of a reference signal in a (G_num)^{th} subcarrier group in the G subcarrier groups and G_num satisfy: Δk=mod(G_num, y) or Δk=G_num, and y is predefined or indicated, y is equal to a difference between subcarrier sequence numbers of two adjacent reference signals, or y is equal to a difference between maximum subcarrier sequence numbers of two adjacent reference signals.

In an optional implementation, an offset Δk of a start location of a reference signal in an i^{th} subcarrier group in the G subcarrier groups relative to a first subcarrier in the subcarrier group is an i^{th} value in a range of [0, y].

In an optional implementation, the communication apparatus 1400 is a terminal device, and the transceiver module 1420 is further configured to receive the offset information.

In an optional implementation, the communication apparatus 1400 is a network device, and the transceiver module 1420 is further configured to send the offset information.

In an optional implementation, the communication apparatus 1400 is a terminal device, the transceiver module is further configured to receive a first index, and the processing module is further configured to determine G and the offset information based on the first index and a third mapping relationship, where the third mapping relationship is a mapping relationship between a plurality of indexes and a plurality of groups of parameters, the plurality of indexes are in one-to-one correspondence with the plurality of groups of parameters, and one group of parameters includes one group of G and offset information.

In an optional implementation, a subcarrier sequence number included in the reference signal pattern is determined based on the reference signal density.

In an optional implementation, the subcarrier sequence number SC_index included in the reference signal pattern satisfies:
SC_index=(2n+k)/ρ+Δk, SC_index=(2n+k)/ρ+x+Δk, SC_index=(2n+k/2)/ρ+Δk, or SC_index=(2n+k/2)/ρ+x+Δk, where p is the reference signal density in the bandwidth used by the communication apparatus 1400, n=0, 1, . . . , or N×ρ/2, N is the quantity of resource blocks or subcarriers included in the bandwidth used by the communication apparatus 1400, k=0 or 1, and x is an original offset of a reference signal.

In an optional implementation, the communication apparatus 1400 is a terminal device, and the transceiver module 1420 is further configured to receive indication information, where the indication information indicates that the communication apparatus 1400 uses the reserved tone.

In an optional implementation, the communication apparatus 1400 is a network device, and the transceiver module 1420 is further configured to send indication information, where the indication information indicates that a terminal device uses the reserved tone.

It should be understood that in this embodiment of this application, the processing module 1410 may be implemented by a processor or a processor-related circuit component, and the transceiver module 1420 may be implemented by a transceiver, a transceiver-related circuit component, or a communication interface.

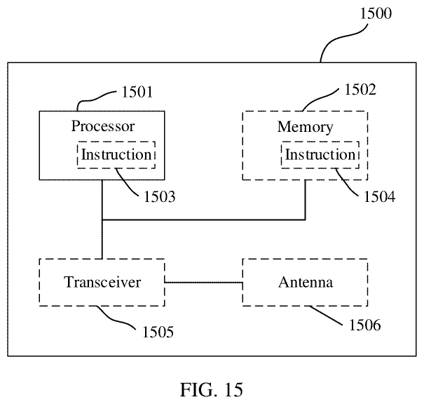

FIG. 15 is a schematic block diagram of a communication apparatus 1500 according to an embodiment of this application. The communication apparatus 1500 may be a communication apparatus, and can implement functions of the first communication apparatus or the second communication apparatus in the method provided in embodiments of this application. Alternatively, the communication apparatus 1500 may be an apparatus that can support the first communication apparatus or the second communication apparatus in implementing a corresponding function in the method provided in embodiments of this application. The communication apparatus 1500 may be a chip system. In this embodiment of this application, the chip system may include a chip, or may include a chip and another discrete device. For a specific function, refer to descriptions of the foregoing method embodiments. Alternatively, the communication apparatus 1500 may be a first communication apparatus or a second communication apparatus, and can implement a function of the first communication apparatus or the second communication apparatus in the method provided in embodiments of this application. Alternatively, the communication apparatus 1500 may be an apparatus that can support the first communication apparatus or the second communication apparatus in implementing a corresponding function in the method provided in embodiments of this application. The communication apparatus 1500 may be a chip system. In this embodiment of this application, the chip system may include a chip, or may include a chip and another discrete device. For a specific function, refer to descriptions of the foregoing method embodiments.

The communication apparatus 1500 includes one or more processors 1501, configured to implement or support the communication apparatus 1500 in implementing the function of the first communication apparatus or the second communication apparatus in the method provided in embodiments of this application. For details, refer to the detailed descriptions in the method examples. The one or more processors 1501 may alternatively be configured to implement or support the communication apparatus 1500 in implementing the function of the first communication apparatus or the second communication apparatus in the method provided in embodiments of this application. For details, refer to the detailed descriptions in the method examples. The processor 1501 may also be referred to as a processing unit or a processing module, and may implement a specific control function. The processor 1501 may be a general-purpose processor, a dedicated processor, or the like. For example, the processor includes a central processing unit, an application processor, a modem processor, a graphics processor, an image signal processor, a digital signal processor, a video codec processor, a controller, a memory, and/or a neural network processor. The central processing unit may be configured to control the communication apparatus 1500, execute a software program, and/or process data. Different processors may be independent devices, or may be integrated into one or more processors, for example, integrated into one or more application-specific integrated circuits.

Optionally, the communication apparatus 1500 includes one or more memories 1502, configured to store instructions 1504. The instructions may be run on the processor 1501, so that the communication apparatus 1500 performs the method described in the foregoing method embodiments. The memory 1502 and the processor 1501 may be separately disposed, or may be integrated together, or it may be considered that the memory 1502 is coupled to the processor 1501. The coupling in this embodiment of this application may be an indirect coupling or a communication connection between apparatuses, units, or modules in an electrical form, a mechanical form, or another form, and is used for information exchange between the apparatuses, the units, or the modules. The processor 1501 may cooperate with the memory 1502. At least one of the at least one memory may be included in the processor. It should be noted that the memory 1502 is not necessary, and therefore, is illustrated by using a dashed line in FIG. 15.

Optionally, the memory 1502 may further store data. The processor and the memory may be separately disposed, or may be integrated together. In this embodiment of this application, the memory 1502 may be a non-volatile memory, for example, a hard disk drive (HDD) or a solid-state drive (SSD), or may be a volatile memory, for example, a random access memory (RAM). The memory is any other medium that can carry or store expected program code in a form of an instruction or a data structure and that can be accessed by a computer, but is not limited thereto. The memory in embodiments of this application may alternatively be a circuit or any other apparatus that can implement a storage function, and is configured to store the program instructions and/or the data.

Optionally, the communication apparatus 1500 may include instructions 1503 (which may alternatively be referred to as code or a program in some cases), and the instructions 1503 may be run on the processor, so that the communication apparatus 1500 performs the method described in the foregoing embodiments. The processor 1501 may store data.

Optionally, the communication apparatus 1500 may further include a transceiver 1505 and an antenna 1506. The transceiver 1505 may be referred to as a transceiver unit, a transceiver module, a transceiver, a transceiver circuit, an input/output interface, or the like, and is configured to implement sending and receiving functions of the communication apparatus 1500 by using the antenna 1506.

The processor 1501 and the transceiver 1505 described in this application may be implemented on an integrated circuit (IC), an analog IC, a radio frequency integrated circuit (radio frequency identification, RFID), a mixed signal IC, an ASIC, a printed circuit board (PCB), an electronic device, or the like. The communication apparatus described in this specification may be implemented by an independent device (for example, an independent integrated circuit or a mobile phone), or may be a part of a large device (for example, a module that may be embedded in another device). For details, refer to the foregoing descriptions about the terminal device and the network device.

Optionally, the communication apparatus 1500 may further include one or more of the following components: a wireless communication module, an audio module, an external memory interface, an internal memory, a universal serial bus (USB) interface, a power management module, an antenna, a speaker, a microphone, an input/output module, a sensor module, a motor, a camera, a display, or the like. It may be understood that, in some embodiments, the communication apparatus 1500 may include more or fewer components, or some components are integrated, or some components are split. These components may be implemented by hardware, software, or a combination of software and hardware.

It should be noted that the communication apparatus in the foregoing embodiment may be the first communication apparatus (or the second communication apparatus), or may be a circuit, or may be a chip used in the first communication apparatus (or the second communication apparatus), or may be another combined device or component that has a function of the first communication apparatus (or the second communication apparatus). When the communication apparatus is the first communication apparatus (or the second communication apparatus), the transceiver module may be a transceiver, and may include an antenna, a radio frequency circuit, and the like, and the processing module may be a processor, for example, a central processing unit (CPU). When the communication apparatus is a component having a function of the foregoing communication apparatus (or the second communication apparatus), the transceiver module may be a radio frequency unit, and the processing module may be a processor. When the communication apparatus is a chip system, the communication apparatus may be a field programmable gate array (FPGA), an application-specific integrated circuit (ASIC), a system on chip (SoC), a CPU, a network processor (NP), a digital signal processor (DSP), a microcontroller unit (MCU), a programmable controller (PLD), or another integrated chip. The processing module may be a processor of the chip system. The transceiver module or a communication interface may be an input/output interface or an interface circuit of the chip system. For example, the interface circuit may be a code/data read/write interface circuit. The interface circuit may be configured to receive code instructions (where the code instructions are stored in the memory, and may be directly read from the memory, or may be read from the memory through another device) and transmit the code instructions to the processor. The processor may be configured to run the code instructions to perform the method in the foregoing method embodiments. For another example, the interface circuit may alternatively be a signal transmission interface circuit between a communication processor and a transceiver machine.

When the communication apparatus is a chip-type apparatus or circuit, the apparatus may include a transceiver unit and a processing unit. The transceiver unit may be an input/output circuit and/or a communication interface. The processing unit is an integrated processor, a microprocessor, or an integrated circuit.

An embodiment of this application further provides a communication system. Specifically, the communication system includes at least one first communication apparatus and at least one second communication apparatus. For example, the communication system includes the first communication apparatus and the second communication apparatus that are configured to implement related functions in FIG. 6. For details, refer to the related descriptions in the method embodiments.

An embodiment of this application further provides a computer-readable storage medium including instructions. When the instructions are run on a computer, the computer is enabled to perform the method performed by the first communication apparatus in FIG. 6. Alternatively, when the instructions are run on a computer, the computer is enabled to perform the method performed by the second communication apparatus in FIG. 6.

An embodiment of this application further provides a computer program product including instructions. When the instructions are run on a computer, the computer is enabled to perform the method performed by the first communication apparatus in FIG. 6. Alternatively, when the instructions are run on a computer, the computer is enabled to perform the method performed by the second communication apparatus in FIG. 6.

An embodiment of this application provides a chip system. The chip system includes a processor, and may further include a memory, configured to implement functions of the first communication apparatus or the second communication apparatus in the foregoing method, or configured to implement functions of the communication apparatus in the foregoing method. The chip system may include a chip, or may include a chip and another discrete device.

It should be understood that sequence numbers of the foregoing processes do not mean execution sequences in various embodiments of this application. The execution sequences of the processes should be determined according to functions and internal logic of the processes, and should not be construed as any limitation on the implementation processes of embodiments of this application.

A person of ordinary skill in the art may be aware that, in combination with illustrative logical blocks described in embodiments disclosed in this specification and steps may be implemented by electronic hardware or a combination of computer software and electronic hardware. Whether the functions are performed by hardware or software depends on particular applications and implementation constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments.

In the several embodiments provided in this application, it should be understood that the disclosed system, apparatus and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

When the functions are implemented in the form of a software functional unit and sold or used as an independent product, the functions may be stored in a computer-readable storage medium. Based on this understanding, a part that essentially contributes to the technical solutions of this application or a part of the technical solutions may be embodied in a form of a software product. The computer software product is stored in a storage medium, and includes several instructions for enabling a computer device (which may be a personal computer, a server, a network device, or the like) to perform all or some steps of the methods in embodiments of this application. The foregoing storage medium includes any medium, for example, a USB flash drive, a removable hard disk, a read-only memory (read-only memory, ROM), a RAM, a magnetic disk, or an optical disc, that can store program code.

It is clear that a person skilled in the art can make various modifications and variations to this application without departing from the scope of this application. This application is intended to cover these modifications and variations of this application provided that they fall within the scope of protection defined by the following claims and their equivalent technologies.

1. A communication method, comprising:
determining, by a communication apparatus, to use a reserved tone;
determining, by the communication apparatus, a reference signal pattern and a tone reservation (TR) pattern, wherein the reference signal pattern comprises a first reference signal sub-pattern and a second reference signal sub-pattern, and the second reference signal sub-pattern is an offset of the first reference signal sub-pattern in a time domain and/or a frequency domain; and
performing, by the communication apparatus, data transmission based on the reference signal pattern and the TR pattern.

2. The method according to claim 1, further comprising:
determining, by the communication apparatus, not to use the reserved tone, wherein the reference signal pattern comprises only the first reference signal sub-pattern.

3. The method according to claim 1, wherein a bandwidth used by the communication apparatus comprises G subcarrier groups, at least one subcarrier group, in the G subcarrier groups, uses the first reference signal sub-pattern, at least one subcarrier group, in the G subcarrier groups, uses the second reference signal sub-pattern, and G is an integer greater than or equal to 2.

4. The method according to claim 3, further comprising:
determining, by the communication apparatus, G based on a first density, wherein the first density is a reference signal density in the bandwidth used by the communication apparatus, wherein
the communication apparatus further determines G based on the first density and a first mapping relationship between a quantity of subcarrier groups and a reference signal density;
the communication apparatus further determines G based on the first density, a first quantity of resources, and a second mapping relationship among a quantity of subcarrier groups, a reference signal density, and a quantity of resources, and the first quantity of resources is a quantity of resource blocks or subcarriers comprised in the bandwidth used by the communication apparatus;
the communication apparatus further determines G based on a first coefficient and the first density, wherein G is a product of the first coefficient and the first density, and the first coefficient is predefined, preconfigured, or indicated; or
G is predefined, agreed on, or preconfigured.

5. The method according to claim 3, wherein the communication apparatus is a terminal device, and the method further comprises:
receiving, by the communication apparatus, a value of G; or
receiving, by the communication apparatus, a second quantity of resources, and determining G based on the second quantity of resources, wherein the second quantity of resources is a quantity of resource blocks or subcarriers comprised in one subcarrier group.

6. The method according to claim 3, wherein the communication apparatus is a network device, and the method further comprises:
sending, by the communication apparatus, a value of G; or sending, by the communication apparatus, a second quantity of resources used to determine G.

7. The method according to claim 1, further comprising:
determining, by the communication apparatus, offset information indicating an offset between the second reference signal sub-pattern and the first reference signal sub-pattern in a time domain and/or a frequency domain.

8. The method according to claim 7, wherein the determining the offset information comprises:
determining, by the communication apparatus, the offset information based on group numbers of the G subcarrier groups, wherein an offset Δk of a start location of a reference signal in a (G_num)^{th} subcarrier group in the G subcarrier groups and G_num satisfy: Δk-mod(G_num, y) or Δk=G_num, and y is predefined or indicated, y is equal to a difference between subcarrier sequence numbers of two adjacent reference signals, or y is equal to a difference between maximum subcarrier sequence numbers of two adjacent reference signals.

9. The method according to claim 7, wherein an offset Δk of a start location of a reference signal in an i^{th} subcarrier group, in the G subcarrier groups relative to a first subcarrier in the subcarrier group, is an i^{th} value in a range of [0, y].

10. The method according to claim 7, wherein the communication apparatus is a terminal device, and determining the offset information comprises: receiving, by the communication apparatus, the offset information.

11. A communication apparatus, comprising:
a processor; and
a transceiver, wherein the processor, operating in conjunction with the transceiver, cause the communication apparatus to:
determine to use a reserved tone;
determine a reference signal pattern and a tone reservation (TR) pattern, wherein the reference signal pattern comprises a first reference signal sub-pattern and a second reference signal sub-pattern, and the second reference signal sub-pattern is an offset of the first reference signal sub-pattern in a time domain and/or a frequency domain; and
the transceiver is configured to perform data transmission based on the reference signal pattern and the TR pattern.

12. The apparatus according to claim 11, wherein the apparatus is further caused to determine not to use a reserved tone, wherein the reference signal pattern comprises only the first reference signal sub-pattern.

13. The apparatus according to claim 11, wherein a bandwidth used by the communication apparatus comprises G subcarrier groups, at least one subcarrier group, in the G subcarrier groups, uses the first reference signal sub-pattern, at least one subcarrier group, in the G subcarrier groups, uses the second reference signal sub-pattern, and G is an integer greater than or equal to 2.

14. The apparatus according to claim 13, wherein apparatus is further caused to:
determine G based on a first density, wherein the first density is a reference signal density in the bandwidth used by the communication apparatus, wherein
the apparatus is further caused to:
determine G based on the first density and a first mapping relationship between a quantity of subcarrier groups and a reference signal density;
determine G based on the first density, a first quantity of resources, and a second mapping relationship among a quantity of subcarrier groups, a reference signal density, and a quantity of resources, and the first quantity of resources is a quantity of resource blocks or subcarriers comprised in the bandwidth used by the communication apparatus;
determine G based on a first coefficient and the first density, wherein G is a product of the first coefficient and the first density, and the first coefficient is predefined, preconfigured, or indicated; or
G is predefined, agreed on, or preconfigured.

15. The apparatus according to claim 13, wherein the communication apparatus is a terminal device, and the apparatus is further caused to:
receive a value of G; or
receive a second quantity of resources, and determine G based on the second quantity of resources, wherein the second quantity of resources is a quantity of resource blocks or subcarriers comprised in one subcarrier group.

16. The apparatus according to claim 13, wherein the communication apparatus is a network device, and the apparatus is further caused to:
send a value of G;
send a second quantity of resources used to determine G.

17. The apparatus according to claim 11, wherein the apparatus is further caused to:
determine offset information indicating an offset between the second reference signal sub-pattern and the first reference signal sub-pattern in a time domain and/or a frequency domain.

18. The apparatus according to claim 17, wherein the apparatus is further caused to:
determine the offset information based on group numbers of the G subcarrier groups, wherein an offset Δk of a start location of a reference signal in a (G_num)^{th} subcarrier group in the G subcarrier groups and G_num satisfy: Δk=mod(G_num, y) or Δk=G_num, and y is predefined or indicated, y is equal to a difference between subcarrier sequence numbers of two adjacent reference signals, or y is equal to a difference between maximum subcarrier sequence numbers of two adjacent reference signals.

19. The apparatus according to claim 17, wherein an offset Δk of a start location of a reference signal in an i^{th} subcarrier group, in the G subcarrier groups relative to a first subcarrier in the subcarrier group, is an i^{th} value in a range of [0, y].

20. The apparatus according to claim 17, wherein the communication apparatus is a terminal device, and the apparatus is further caused to receive the offset information.
